(19) United States
(12) Patent Application Publication
(10) Pub. No.: US 2026/0319132 A1
(43) Pub. Date: Oct. 15, 2026

(54) SOFTWARE PLATFORM TO CONDUCT BUILDING ONSITE WEATHER FORECASTING WITH CROWDSOURCING DATA

(71) Applicants: Bing Dong, Manlius, NY (US); Wenbo Wu, San Antonio, TX (US)

(72) Inventors: Bing Dong, Manlius, NY (US); Wenbo Wu, San Antonio, TX (US)

(73) Assignee: Syracuse University, Syracuse, NY (US)

(21) Appl. No.: 18/996,480

(22) PCT Filed: Jul. 18, 2023
(86) PCT No.: PCT/US2023/070391

§ 371 Date: Jan. 17, 2025

Related U.S. Application Data
(60) Provisional application No. 63/390,712, filed on Jul. 20, 2022.

(51) Int. Cl. G01W 1/10; G01W 1/00

(52) U.S. Cl. CPC G01W 1/10; G01W 2001/006

(57) ABSTRACT

A software based platform for conducting building on-site weather forecasting for any arbitrary location. The software platform utilizes crowdsourced data from neighboring personal weather stations and public weather stations to provide an accurate weather forecast for a given building using a spatial-temporal modeling framework. Data is provided at a fine time resolution (e.g., at 5-minute frequency) and spatial resolution (e.g., arbitrary location vs grid). The spatial-temporal correlation of weather variables between the target building and a set of neighboring weather stations allow for improved forecasting performance.

### STATEMENT REGARDING FEDERALLY SPONSORED RESEARCH AND DEVELOPMENT

The invention was made with government support under Grant No. DE-AC02-06CH11357 awarded by the US Department of Energy. The government has certain rights in the invention.

### 1. FIELD OF THE INVENTION

The invention is an approach for predicting weather conditions and, more particularly a system that can provide weather predictions at a location using a combination of official weather stations and crowdsourced personal weather stations.

### 2. DESCRIPTION OF THE RELATED ART

Weather forecasting is a critical component in building energy management. The challenges of obtaining accurate weather forecasts for the purpose of better building controls come from the following factors. First, weather data is usually collected from weather stations which sometimes have limited availability and accessibility to retrieve. At the same time, most public weather stations are generally set at specific locations sparsely such as airports. The weather could be dramatically different from the locations where buildings at due to complex terrain characteristics or heat island effect in an urban area. Second, input data for building controls sometimes require a fine time resolution (such as 20 minutes or shorter) and shorter look-ahead time, but weather data are commonly available at more coarse time resolution (e.g., hourly, or daily basis). Finally, weather variables such as solar irradiance, humidity, and precipitation are highly correlated and contain huge uncertainty characteristics causing difficulty of forecasting accuracy. Inherent uncertainties due to weather predictions would affect further building management, and such awareness has driven several researchers to improve the accuracy of weather forecasting. Traditionally, observations from public weather stations (e.g., airports) are used in the forecast models. However, due to the limited number and sparse locations of weather stations in a region, performance of weather forecasting based on conventional public weather station data is not always accurate for local building energy management.

As one of the important elements for the building energy management, accurate weather forecasting in a Model Predictive Control (MPC) of a building would certainly improve building operations in terms of energy consumption. For instance, weather forecasts are used as inputs in for active and passive building thermal storage systems for an office building. Weather predictions in were used as predictors for real-time dynamic building operations of heating systems.

In terms of weather information, building operators heavily depend on online weather channels or airport weather forecasting. There are several sources for meteorology data that the temperature variables are retrieved from. For example, A roof-top device that could sensor the ambient temperature within 1-kilometer radius for Model Predictive Control (MPC) design in smart building systems is a convenient source and more accurate in real-time temperature for the building under the roof. Often, researchers use weather data from publicly available sources such as airports, local weather stations or online weather forecast websites. These weather data are often representing the entire city or region-wise, or even larger scale, which possibly contain spatial effects since there is a relative distance between the location of collected weather data and the target MPC building. Roof-top devices would radically be more accurate to use for its corresponding building operations, but oftentimes not all buildings have such resources equipped for the building. Thus, a neighboring weather station could be a rational option instead of airport or online weather information regarding geographical distance. There are various of temperature forecasting approaches, which could be categorized into statistical modeling, machine learning, and numerical weather predictions (NWP). Statistical models for temperature forecasting are classical approaches, among which the time series related models are commonly used since the inputs are usually historical values. For weather forecasting, a time-series model is largely used, in which the model accounts for the historical information of the weather itself. Autoregressive (AR) and Autoregressive and moving Average (ARMA) models are used as the stochastic method, then Exponentially Weighted Moving Average (EWMA) is used to remove the non-stochastic elements before using AR model as the deterministic-stochastic model, and then lastly combined Autoregressive with Exogenous model (ARX) and EWMA-AR as the expanded deterministic-stochastic method. Kalman Filters have been used to predict the outside air-temperature for the purpose of building optimization such as the Energy Efficient Building Climate Control. Others have used Hammerstein Wiener as a type of generalized model for onsite temperature predictions to have accurate day-ahead weather inputs for the MPC control model under 15- or 60-minutes frequency. Some approaches compare weather data from multiple online weather resources and uses weighted linear models for the short-term temperature forecasting. The linear combinations of multiple online resources are collected differently and potentially include the spatial effect so that it is claimed to have better accuracy than the predictions from individual sites.

In recent decades, machine learning is a popular approach which provides a sophisticated but efficient computational ability to capture nonlinear patterns of weather data. In addition to traditional statistical methods, machine learning such as Artificial Neural Network (ANN) has become widely used given its high accuracy of forecasting along with novel variations such as Deep Neural Network (DNN) and Recurrent Neural Network (RNN). More other machine learning methods such as decision trees, gradient boosting, and random forests are also widely used as complex and flexible methods. A combination of regression tree and Radial Basis Feed-forward Neural Network (RBFN) has been used as the proposed model in short-term hourly temperature forecasting. This method does not need a large database for training the neural network, and the predictions are then used as the main variables input for a Short Term Electric Load Forecasting (STLF) system. Nonlinear Autoregressive Neural Network (NAR) and NAR with Exogenous inputs (NARX) has been proposed to predict cloudiness, solar radiation, and temperature, which are observed by the top-roof building sensor. ANN-based modeling method has also been used for multi-zone temperature forecasting inside a commercial building.

Lastly, NWP models are calculated mathematically according to actual weather conditions by certain initial conditions. NWP models forecast weather quantitatively and objectively tend to be used for large scale forecasting. Some approaches apply Bayesian Model Averaging (BMA) for calibrating ensembles of temperature forecasts, which are produced by the Hungarian Meteorological Service (HMS). BMA is a standard method for combining predictive distribution from different sources. The BMA predictive probability density function is used to compare with the calibrated ensemble approach in the probabilistic forecasts of temperature. Ensemble Model Output Statistics (EMOS) and minimum CRPS Estimation was used for over 294 observed stations, which 194 of them are for model fitting and the remaining 100 stations are for validation. The deterministic-style EMOS forecasts method is proposed as an easy-to-implement post processing technique that takes account for both forecasts' bias and under dispersion. The precooling potential via simulations from real data in the NWP platform has been assessed, which uses the predicted temperature data from the NWP model. Some approaches have used 7 out of 189 outputs from the Weather Research and Forecasting (WRF) model, which is an NWP approach, and then applied ANN method for post-processing to forecast 24-ahead of solar irradiance.

Each forecasting approach has its own pros and cons regarding to the climate type and purpose. To improve weather forecasting performance by leveraging the pros from different approaches, hybrid models with two or more approaches have been developed. For example, Moving Average models (SPMA and EWMA) have been used with a combination of 3 different anchoring modification approaches and two machine learning models, FTDNN and NARX, to forecast temperature in 11 cities among these 14 models. By the temperature forecasting models of 11 geographical locations in 4 seasons using 14 model methodologies, the short-term forecasting models are compared and evaluated for MPC in intelligent building operation. The anchoring modifications on time-series models are claimed to perform better in accuracy. Others have used the Bin method, unbiased random walk and SARIMA to predict outdoor temperature using data from onsite weather station of the city. The temperature forecasts are used as inputs for the MPC of building thermal storage system.

Models that explicitly utilize spatial temporal correlation approach has been developed in various weather variables such as solar and temperature forecasting. Using the solar irradiance data from five locations in Colorado in United States, the Autoregressive with Exogenous inputs (ARX) base spatio-temporal forecast model was used with the exogenous inputs comprising the historical values of solar irradiance and cloud cover percentage at neighbor sites. Compared with the temporal-only AR model as the benchmark method, the ARX base spatio-temporal model tends to perform better in larger forecast horizons such as 24-hour ahead forecasting. As weather information across five locations are correlated with each other, spatial correlation is necessary to be included in addition to the autocorrelation of the station itself. Weighted regression and an AR model have been used with external output to implement two types of hybrids numerical and statistical regression prediction models. Compared with other numerical prediction approaches, the forecasting ability under high spatial resolution domain on temperature forecasting was superior to other base models in this study. The weather data from multiple sources can be sought for redundancy because the weather data from a single channel are unreliable. Though the data are retrieved from multiple internet links, a linear combination of these resources was proposed to perform the short-term temperature forecasting.

While these systems can provide weather forecasting, the approaches fail to provide accurate enough predictions for use in predicting and controlling building energy consumption due to the lack of localized information for a particular building location. As a result, there is a need in the art for an approach that can conduct building on-site weather forecasting for any arbitrary location with useful time and spatial resolution.

### BRIEF SUMMARY OF THE INVENTION

The present invention provides a platform to conduct building on-site weather forecasting for any arbitrary location. The platform utilizes the crowdsourcing data from neighboring personal weather stations (PWS) to improve the weather forecast accuracy around buildings through a novel spatial-temporal modeling framework. Crowdsourcing weather data from PWS is leveraged in addition to public data sources. In this way, the data is at much finer time resolution (e.g., at 5-minute frequency) and spatial resolution (e.g., arbitrary location vs grid). The platform also incorporates spatial-temporal correlation information of weather variables between the target building and a set of neighboring PWSs so that underlying correlations can be effectively captured to improve forecasting performance. The overall forecasting performance the platform has been demonstrated to outperform NOAA by up to 50%.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of the present invention.

FIG. 2 is a map showing temperature correlation and approximation around target location.

FIG. 3 is a map of local forecasts for target location (red star) from neighboring stations (blue dots).

FIG. 4 is a graph of local model training and forecasting process (without rolling window.

FIG. 5 is a graph of local model training process with rolling windows.

FIGS. 6A through 6D are a series of graphs of optimal model parameters for the platform of the present invention.

FIG. 7 is a series of graphs of forward feature selection according to the present invention.

FIG. 8 is a series of graphs of the model performance of different forecasting horizon F.

FIGS. 9A and 9B are a series of graphs of the time-series of different look-ahead forecasts and observed temperature.

FIGS. 10A through 10B are a series of graphs of the model performance at different hours of the day.

FIG. 11 is a series of graphs of the model performance of different forecasting horizon F for SATC location.

FIG. 12 is a series of graphs of the time-series of different look-ahead forecasts and observed temperature in different seasons for SATC location.

FIG. 13 is map of San Antonio with selected target PWSs (red solid circles) out of available PWSs (black solid circles).

FIG. 14 is a series of graphs of the percentage of the target PWSs that outperformed NOAA airport forecasts.

FIG. 15 is a flowchart of the process of the data preparation according to the present invention.

FIG. 16 is a graph of the CoE building and the surrounding PWS in Syracuse.

FIG. 17 is a graph of NOAA grid points.

FIG. 18 is a Map of Syracuse with selected target PWSs.

FIG. 19 is a series of graphs of the model performance of different forecasting horizon F.

FIGS. 20A and 20B are a series of graphs of the time-series of different look-ahead forecasts and observed temperature.

FIG. 21 is a graph of the results of simulation of real-time implementation.

FIG. 22 is a pair of graphs of the time-series of different look-ahead forecasts and observed temperature.

FIG. 23 is a map of Syracuse with selected target PWSs (Red star: CoE building; blue airplane: Syracuse Hancock International Airport; black solid circle: PWSs; red solid circle: selected PWSs).

FIG. 24 is a series of graphs of the percentage of the target PWSs that have forecasts outperformed the NOAA airport forecasts.

FIG. 25 is a map of Chicago with selected target PWSs.

FIG. 26 is a series of graphs of the percentage of the target PWSs that have forecasts outperformed the NOAA airport forecasts.

FIG. 27 is a schematic of exemplary application for implementing the present invention.

FIG. 28 is a schematic of the exemplary application of FIG. 27 showing a graphical output of the results of the present invention.

### DETAILED DESCRIPTION OF THE INVENTION

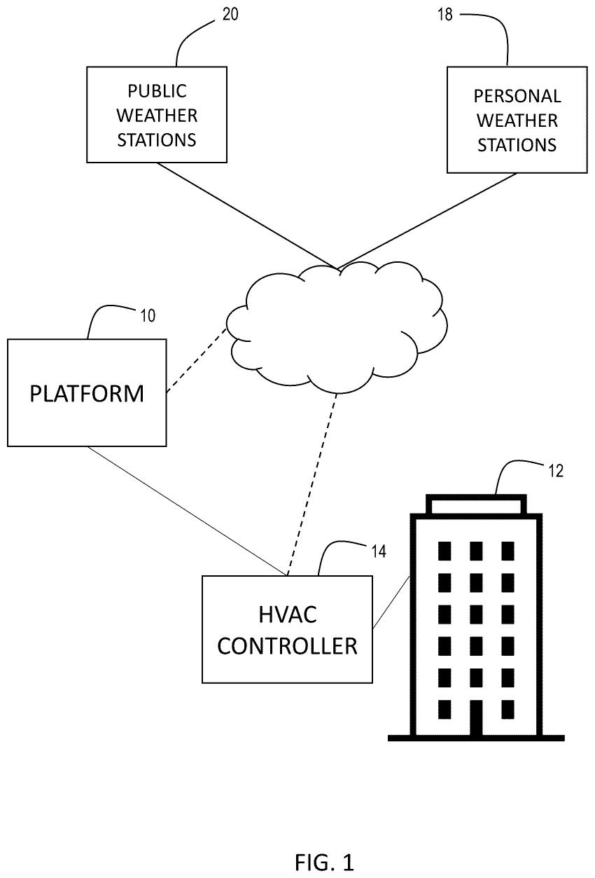

Referring to the figures, wherein like numerals refer to like parts throughout, there is seen in FIG. 1 a platform 10 for use in providing building location specific weather predictions for use as a Model Predictive Control (MPC) of a building heating, ventilation and air conditioning (HVAC) system in a building 12. Platform 10 is a programming computing device that is coupled to the building controller 14 of the HVAC system and programmed according to the present invention. Platform 10 may also be implemented remotely via a server that is interconnected to building controller 14 via the internet. Platform 10 uses a crowdsourcing approach by utilizing the weather data collected from individual personal weather stations 18 scattered around the area of interest as well as local public weather stations 20. Compared with existing methods using onsite observations at a single location or the weather data from the airport, not only the additional data resources help building a more accurate forecasting model with spatial-temporal correlation information, but also provide flexibilities of choosing the forecasting frequency (e.g., at every 5 minutes) based on how frequent the data are collected from personal weather stations. More importantly, crowdsourcing data enables platform 10 to make accurate forecasts to an arbitrary location. Hence, platform 10 provides forecasts for specific locations with fine time resolution and leads to accuracy improvement in building energy simulation.

From the methodological aspect, platform 10 employs a general spatial-temporal modeling framework that explicitly leverages temporal and spatial correlation information as the framework structured from the neighboring PWSs. This framework can be equipped with different statistical or advanced machine learning models to make weather forecasts for a given look-ahead period. In addition, the meta-parameters of the proposed framework such as number of neighboring stations and the number of lagged timesteps as model inputs provide meaningful insights on how the crowdsourcing data from the neighboring stations could potentially impact the weather predictions of the target location. Platform 10 demonstrates how crowdsourcing data can be effectively used for local weather forecasting in the context of building energy management for cities in different climate zones and in different seasons.

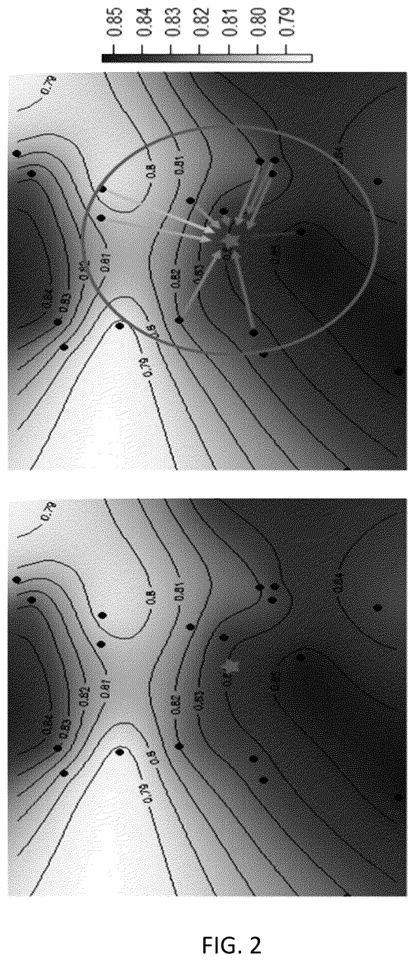

Platform 10 is programmed with software to implement a general spatial-temporal modeling framework that models temperature distribution and correlation over an area of interest as a contour surface. During an implementation, only a limited number of weather stations may be deployed to observe weather. Weather at locations other than those available stations needs to be estimated based on historical weather data that are available at discrete locations (i.e., neighboring stations). Therefore, platform 10 approximates the overall correlation with a series of point-to-point correlations. As seen in FIG. 2, the spatial correlation between any arbitrary locations and the target center location (the smoothed contour) can be approximated by the pairwise association (the arrows) between neighboring locations to the target center location

In the setup of the spatial-temporal modeling framework of platform 10, the future values of target weather variables (e.g., temperature) at an arbitrary target location can be modeled by the historical weather information from the surrounding PWSs. Specifically, forecasts of future weather at the target location are made at the present time from each of the surrounding PWSs. Using the historical weather observations lends itself to capture the temporal associations in the weather variables. If geographical information (e.g., relevant distances to the target location) is used as a model input, then the spatial effects can also be incorporated. Hence, an ensemble of the local forecasts from the neighboring PWSs are used as a final forecast for the target location. In this way, the spatial associations are further utilized. There are often some alternative weather forecasts available from other sources, such as airport forecasts from National Oceanic and Atmospheric Administration (NOAA). The framework of platform 10 can either take these alternative forecasts as model inputs or ensemble the forecasting results with existing ones to further improve the prediction accuracy.

For an arbitrary location so, the local forecast model predicts the future weather variable Yₛ_{ₒ}_{,t+F} using geographical information and historical weather observations collected up to the present time t. The model can be presented as:

$${Y}_{{s}_{0} , t + F} = {G}_{t \to t + F}^{LR} ( {Ω}_{t , L ; {s}_{i}} ) + {ε}_{t} = {G}_{t \to t + F}^{LR} ( \underbrace{{Y}_{{s}_{i} , t} , {Y}_{{s}_{i} , t - 1} , … , {Y}_{{s}_{i} , t - L + 1}}_{Endogenous Temporal} , \underbrace{{X}_{{s}_{i} , t} , {X}_{{s}_{i} , t - 1} , … , {X}_{{s}_{i} , t - L + 1}}_{Exogenous Temporal} , \underbrace{{δ}^{lon} ( {s}_{i} , {s}_{0} ) , {δ}^{lat} ( {s}_{i} , {s}_{0} )}_{Spatial} ) + {ε}_{t} \qquad ( 1 )$$

where

$${G}_{t \to t + F}^{LR} ( \cdot )$$

is a general function (model), which captures the underlying association between the response variable Yₛ_{ₒ}_{,t+F} and the model inputs Ω_{t,L;s}_{ᵢ} that contains various predictive features, which were grouped into categories such as historical weather and geographical information at the location sᵢ. The random noise & is usually assumed to have E(εₜ)=0. The structure of the model, namely

$${G}_{t \to t + F}^{LR} ( \cdot ) ,$$

can either be linear or nonlinear, parametric or nonparametric. The subscript, t→t+F, indicates that the model is used at the present time t to forecast the future weather variable at t+F. The superscript L indicates that the lagged of historical weather variables up to Z time points prior to the present time are considered as input features. Note that, the L time points in the model does not necessarily have to be consecutive time points during implementation. Instead, choosing diurnally associated time lags (e.g., 12 hours and 24 hours) in larger intervals would potentially be more efficient and less noise. The superscript R is used to restrict the locations, sᵢ, of where the input features were collected to be one of the R-nearest PWSs to the target location so. Therefore, there is a critical assumption of model (1) is: at every fixed time t with given values of F and L,

$${G}_{t \to t + F}^{LR} ( \cdot )$$

is assumed to be homogenous for all R-nearest stations around the target location s₀. The larger value of R is used, the stronger assumption on the model is imposed. Hence, the model structure depends on meta-parameters F, L and R.

Model (1) is a general and flexible framework that can include many classic statistics models as its special cases. When only one location sᵢ is considered (or equivalently setting R=1) and s₀ is set to be this location sᵢ, the model is reduced to a time-series model, which only relies on the temporal relationship between input features and the response variable. In this case, δ^{lon}(sᵢ, s₀)=δ^{lat}(sᵢ, s₀)=0. When L=0 was set and only the Endogenous Temporal features Yₛ_{ᵢ}_{,t} considered, the model is reduced to a classic spatial model, which captures only associations in the response variable at different locations.

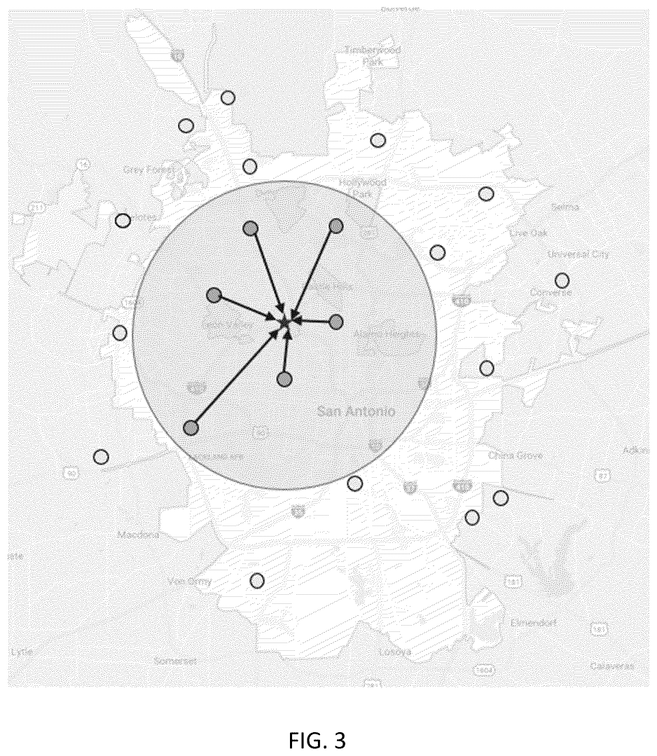

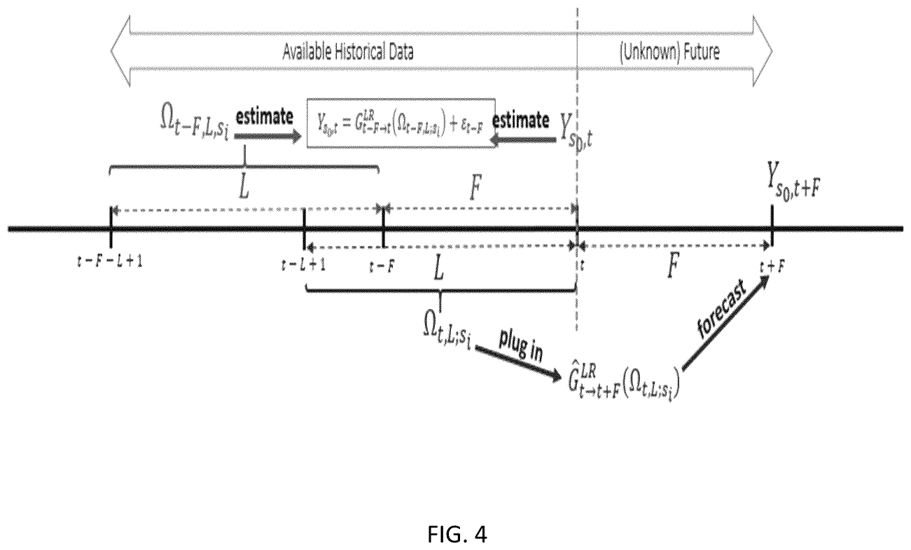

In model (1), each of the neighboring station, sᵢ, provides a different forecast for the target location so based on its own weather inputs and geographical relevance to so as illustrated in FIG. 3. To further incorporate the spatial influence of different locations and combine their predictions, the ensemble forecast is defined as

$${\hat{Y}}_{{s}_{0} , t + F} = {\sum }_{i = 1}^{R} \{ {ω}_{i} \times {G}_{t \to t + F}^{LR} ( {Ω}_{t , L ; {s}_{i}} ) \} , \qquad ( 2 )$$

where

$${ω}_{i} = \frac{1 / d ( {s}_{i} , {s}_{0} )}{{\sum }_{i}^{R} ( 1 / d ( {s}_{i} , {s}_{0} ) )}$$

is a weight assigned to the local forecast from the PWS sᵢ when taking the weighted average among all local forecasts for location s₀. Note that ωᵢ is computed based on the geo-distance between sᵢ and s₀ so that more weights are given to local forecasts from nearer stations.

In order to use the local forecast model (1) at t to predict the response variable at t+F, a model needs to be estimated (trained) at t using only information available up to time t. In other words, an estimated form

$${\hat{G}}_{t \to t + F}^{LR} ( \cdot )$$

must be obtained using data collected at or before t. Once the model is estimated, the forecast for location so using model input variables at location sᵢ can be obtained as:

$${\hat{Y}}_{{s}_{0} , t + F} = \hat{E} [ {Y}_{{s}_{0} , t + F} ] = {\hat{G}}_{t \to t + F}^{LR} ( {Ω}_{t , L ; {s}_{i}} ) = {G}_{t \to t + F}^{LR} ( {Y}_{{s}_{i} , t} , {Y}_{{s}_{i} , t - 1} , … , {Y}_{{s}_{i} , t - L + 1} , {X}_{{s}_{i} , t} , {X}_{{s}_{i} , t - 1} , … , {X}_{{s}_{i} , t - L + 1} , {δ}^{lon} ( {s}_{i} , {s}_{0} ) , {δ}^{lat} ( {s}_{i} , {s}_{0} ) ) . \qquad ( 3 )$$

Since the latest observed data are collected at time t, there is need to use the response variable observed at t and input features collected at or before t-F to estimate the model. By doing so, it is possible to assume that

$${G}_{t \to t + F}^{LR} ( \cdot ) ≡ {G}_{t - F \to t}^{LR} ( \cdot )$$

so that once the model

$${G}_{t - F \to t}^{L R} ( \cdot )$$

is estimated using we training data {Yₛ_{₀}_{,t},Ω_{t-F,L;s}_{ᵢ}} at t−F, it can be used at t to forecast the response variable Yₛ_{₀}_{,t+F} using model inputs Ω_{t,L;s}_{ᵢ} as shown in (3). This training and forecasting process of the local model (1) is illustrated in FIG. 3.

It is worth noting that although in the model (1) can be used to forecast the response variable at any arbitrary location s₀, it is possible to only rely on the observed weather variables at PWSs in estimating

$${G}_{t \to t + F}^{L R} ( \cdot ) .$$

Therefore, for any observed PWS location sⱼ, the response information at sⱼ is paired with the input features observed from each of the R-nearest stations of station j to form the training data. It is possible to let

$${\tilde{s}}_{i}^{j}$$

denote the location of the i-th nearest station to sⱼ for i=1, . . . , R. By definition,

$${\tilde{s}}_{1}^{j} = {s}_{j} .$$

Hence, for each PWS location sⱼ, it is possible to obtain R pairs of observations

$$( {Y}_{{s}_{j} , t} , {Ω}_{t - F , L ; {\tilde{s}}_{1}^{j}} ) , … , ( {Y}_{{s}_{j} , t} , {Ω}_{t - F , L ; {\tilde{s}}_{R}^{j}} ) .$$

By repeating this paring process for each of the Nₜ PWSs at t, it is possible can obtain the training data for estimating

$${G}_{t \to t + F}^{LR} ( \cdot )$$

as demonstrated in Table 1 below.

TABLE 1
Training data preparation at time t

| | |
|---|---|
| Response | |
| (Yₛ_{ⱼ} [symbol] ₜ) | Input Features (Ω_{t-F,L:}\tilde{ₛ}- [symbol] ) |

${Y}_{{s}_{1} , t} \qquad {Y}_{{\tilde{s}}_{1}^{1} , t - F} , … , {Y}_{{\tilde{s}}_{1}^{1} , t - F - L + 1} , {X}_{{\tilde{s}}_{1}^{1} , t - F} , … , {X}_{{\tilde{s}}_{1}^{1} , t - F - L + 1} , {δ}^{lon} ( {\tilde{s}}_{1}^{1} , {s}_{1} ) , {δ}^{lat} ( {\tilde{s}}_{1}^{1} , {s}_{1} )$
${Y}_{{s}_{1} , t} \qquad {Y}_{{\tilde{s}}_{2}^{1} , t - F} , … , {Y}_{{\tilde{s}}_{2}^{1} , t - F - L + 1} , {X}_{{\tilde{s}}_{2}^{1} , t - F} , … , {X}_{{\tilde{s}}_{2}^{1} , t - F - L + 1} , {δ}^{lon} ( {\tilde{s}}_{2}^{1} , {s}_{1} ) , {δ}^{lat} ( {\tilde{s}}_{2}^{1} , {s}_{1} )$

| | |
|---|---|
| . | . |
| . | . |
| . | . |

${Y}_{{s}_{1} , t} {Y}_{{\tilde{s}}_{R}^{1} , t - F} , … , {Y}_{{\tilde{s}}_{R}^{1} , t - F - L + 1} , {X}_{{\tilde{s}}_{R}^{1} , t - F} , … , {X}_{{\tilde{s}}_{R}^{1} , t - F - L + 1} , {δ}^{lon} ( {\tilde{s}}_{R}^{1} , {s}_{1} ) , {δ}^{lat} ( {\tilde{s}}_{R}^{1} , {s}_{1} )$

| | |
|---|---|
| . | . |
| . | . |
| . | . |

${Y}_{{s}_{{N}_{t}} , t} {Y}_{{\tilde{s}}_{1}^{{N}_{t}} , t - F} , … , {Y}_{{\tilde{s}}_{1}^{{N}_{t}} , t - F - L + 1} , {X}_{{\tilde{s}}_{1}^{{N}_{t}} , t - F} , … , {X}_{{\tilde{s}}_{1}^{{N}_{t}} , t - F - L + 1} , {δ}^{lon} ( {\tilde{s}}_{1}^{{N}_{t}} , {s}_{1} ) , {δ}^{lat} ( {\tilde{s}}_{1}^{{N}_{t}} , {s}_{1} )$
${Y}_{{s}_{{N}_{t}} , t} {Y}_{{\tilde{s}}_{2}^{{N}_{t}} , t - F} , … , {Y}_{{\tilde{s}}_{2}^{{N}_{t}} , t - F - L + 1} , {X}_{{\tilde{s}}_{2}^{{N}_{t}} , t - F} , … , {X}_{{\tilde{s}}_{2}^{{N}_{t}} , t - F - L + 1} , {δ}^{lon} ( {\tilde{s}}_{2}^{{N}_{t}} , {s}_{1} ) , {δ}^{lat} ( {\tilde{s}}_{2}^{{N}_{t}} , {s}_{1} )$

| | |
|---|---|
| . | . |
| . | . |
| . | . |

${Y}_{{s}_{{N}_{t}} , t} {Y}_{{\tilde{s}}_{R}^{{N}_{t}} , t - F} , … , {Y}_{{\tilde{s}}_{R}^{{N}_{t}} , t - F - L + 1} , {X}_{{\tilde{s}}_{R}^{{N}_{t}} , t - F} , … , {X}_{{\tilde{s}}_{R}^{{N}_{t}} , t - F - L + 1} , {δ}^{lon} ( {\tilde{s}}_{R}^{{N}_{t}} , {s}_{1} ) , {δ}^{lat} ( {\tilde{s}}_{R}^{{N}_{t}} , {s}_{1} )$ [symbol]
indicates data missing or illegible when filed

Note that the size of the training data at each time t is R×Nₜ and Nₜ might be different at different time points depending on the availability of the data at t. The neighborhood parameter R not only controls the number of data points used for training the model, but also provides additional insights on spatial impact from surrounding stations to the target location. During the real implementation, Nₜ may be more than hundreds of PWS according to the data availability. Due to computing limitations, Nₜ would be chosen to be the same as R in the experiments.

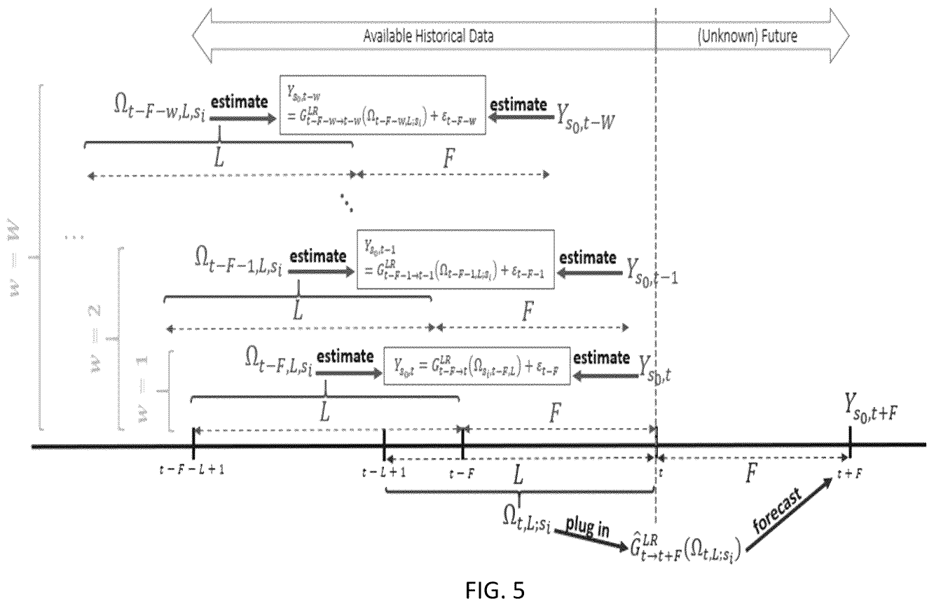

Most machine learning models require a large number of observations to accurately learn and capture the underlying model structure. Hence, a potential improvement to the model training and forecasting illustrated in FIG. 5 is to introduce a rolling window W such that more data are used for training the machine learning models. As a trade-off, it is necessary to assume that the model structure remains unchanged over the rolling period. That is,

$${G}_{t \to t + F}^{LR} ( \cdot ) ≡ {G}_{t - F \to t}^{LR} ( \cdot ) ≡ … ≡ {G}_{t - F - W \to t - W}^{LR} ( \cdot ) .$$

The longer period W is assumed, the stronger assumption of the fixed model structure is imposed. An additional benefit of introducing a rolling window is to verify the persistency of the model structure, hence, to reduce the number of times necessary to train a new model for making the forecast. The updated local model training and forecasting process is illustrated in FIG. 5.

Following the convention in the literature, when a single rolling window is considered (W−1), the values of the response variable (first column in Table) at time t is denoted by

$${𝕐}_{t} = {( {Y}_{{s}_{1} , t} , … , {Y}_{{s}_{1} , t} , … , {Y}_{{s}_{{N}_{t}} , t} , … , {Y}_{{s}_{{N}_{t}} , t} )}^{T}$$

which is a (RNₜ)×1 vector. Note that the values of the response vector are independent of L and R. The input features corresponding to the fixed values of L and R at t−F−w for w=0, . . . , W−1 are denoted by

$${Ω}_{t - F - w , L} = {( {Ω}_{t - F - w , L , {\tilde{s}}_{1}^{1}}^{T} , … , {Ω}_{t - F - w , L , {\tilde{s}}_{R}^{1}}^{T} , … , {Ω}_{t - F - w , L , {\tilde{s}}_{1}^{{N}_{t}}}^{T} , … , {Ω}_{t - F - w , L , {\tilde{s}}_{1}^{{N}_{t}}}^{T} )}^{T}$$

which is a (RNₜ)×(2L+2) matrix. When W rolling windows are considered as illustrated in FIG. 5, the response vector is extended to be

$${𝕐}_{t}^{W} = {( {𝕐}_{t}^{T} , … , {𝕐}_{t - W + 1}^{T} )}^{T} ,$$

which is a (WRNₜ)×1 vector and the input feature matrix is extended to be

$${Ω}_{t - F , L}^{W} = {( {Ω}_{t - F , L}^{T} , … , {Ω}_{t - F - W + 1 , L}^{T} )}^{T} ,$$

which is a (WRNₜ)×(2L+2) matrix.

Without having a direct access to the crowdsourcing data, weather forecasts at local airports are often used to predict building energy consumption. While the airport weather forecasts such as the one provided by NOAA are usually made using sophisticated models, it may not be accurate to some specific locations because there might be an urban heat island effect that causing a temperature difference between downtown and suburban area. Nevertheless, the airport forecasts carry important weather information for the region and can potentially improve the forecasting accuracy of our proposed model. Platform 10 may thus use one of two approaches of incorporation airport forecasts into the model framework.

NOAA provides weather forecasts from 1-hour-ahead up to 24-hour-ahead forecasts. Hence, the model (1) can be further added these airport forecasts at different forecasts horizons as model inputs. Thus, the model (1) becomes

$${Y}_{{s}_{0} , t + F} = {G}_{t \to t + F}^{LR} ( {Ω}_{t , L ; {s}_{i}} ) + {ε}_{t} = {G}_{t \to t + F}^{LR} ( \begin{matrix}\underbrace{{Y}_{{s}_{i} , t} , {Y}_{{s}_{i} , t - 1} , … , {Y}_{{s}_{i} , t - L + 1}}_{Endogenous Temporal} , \underbrace{{X}_{{s}_{i} , t} , {X}_{{s}_{i} , t - 1} , … , {X}_{{s}_{i} , t - L + 1}}_{Exogenous Temporal} , \underbrace{{δ}^{lon} ( {s}_{i} , {s}_{0} ) , {δ}^{lat} ( {s}_{i} , {s}_{0} )}_{Spatial} , \\ {\hat{Y}}_{airport , t + F}\end{matrix} ) + ε \qquad ( 4 )$$

where Ŷ_{airport,t+F} contains up to 24 temperature forecasts in different forecasts horizons for time t+F. When F is small such as 1-hr-ahead forecasts, the airport forecasts are available to use all 24 forecasts because these forecasts are made before time t. When F is set to be 24-hr-ahead, it is possible to only use 24-hr-ahead airport forecasts at the external model inputs because the airport forecasts at other smaller forecast horizons for time t+F have not been performed. Thus, Ŷ_{airport,t+F} contains more forecasts information for smaller F. Therefore, the input Ŷ_{airport,t+F} does not related with R and L. In the training data preparation, the airport forecasts Ŷₐᵢᵣₚₒᵣₜ are always the forecasts for the time stamp that is same as the response variable Y.

Since the airport forecasts are available in this example, it is possible to further ensemble the forecasts from equation (3) with the airport forecasts under the same forecast horizon F by taking the average of the two predictions:

$${\hat{Y}}_{{s}_{0} , t + F}^{ensemble} = ( {\hat{Y}}_{{s}_{0} , t + F} + {\hat{Y}}_{airport , t + F} ) / 2 , \qquad ( 5 )$$

where the equation (5) can be potentially improved by using weighted average by giving the weights depending on the geographical locations similar to the concept mentioned in equation (2). Through this way, the variations of prediction at each time stamp can be further minimized if one believes that these external forecasts are reliable. In our empirical studies, it is demonstrated that the present invention is already accurate without ensemble with external forecasts. However, the ensemble step can mostly further boost the model performance.

### Example

The term “resolution” of model (1) refers to how frequently the forecast is made and it is usually determined by how frequent the weather forecasts are needed for building energy simulation. During the implementations in this study, the resolution is 15 minutes, that is, the model is trained and forecast for every 15 minutes. The term “frequency” in this study refers to how frequent the data are collected or equivalently the time span between any two adjacent time ticks t. In the present example, the weather variables at each PWS are collected roughly at a 5-minute frequency which allows one to choose the model resolution to be any interval that is greater than 5 minutes. The data was aggregated into 15-minute frequencies because it was assumed that the variations in the weather variables are negligible within this interval.

As a critical step in the modeling framework, one needs to obtain an estimate of

$${G}_{t \to t + F}^{L R} ( \cdot )$$

based on the training data. Since no restriction was imposed on

$${G}_{t \to t + F}^{L R} ( \cdot ) ,$$

many traditional models may be used, including linear regression model, time-series models, spatial models, etc. As an alternative, the general modeling framework may be equipped with advanced machine learning models given their demonstrated capabilities of capturing the underlying complex relationship between the response variable and model inputs. In the present example, random forest and the gradient boosting were used as representatives of the advanced machine learning models given their flexibility (e.g., nonparametric) and computational efficiency. Other advanced machine learning or deep learning models can also be adopted in a similar way with permitted computational resources.

Random forest is an ensemble method built on a classification and regression tree. The basic CART works by means of a recursive partitioning of the data that can be represented within a basis function framework. The basic CART is prone to over-fitting, and RF is an ensemble approach to improve on the basic CART. With a random sample of input features, the predictions made by each of the trees are more independent. As a result, averaging over a large number of independent trees leads to great improvement in prediction accuracy. Working with a subsample of smaller number of features, the RF model is capable of handling high-dimensional data, as well as correlated features. When two features are highly correlated, one can use either one as the splitting feature. However, the two features would not split the data in the exact same way given the hierarchical structure in the regression trees. Without imposing any parametric functional form, a RF model is very flexible to accommodate highly localized features of the data. In addition, averaging over the out-of-bag observations significantly reduces the risk of over-fitting. There are three major tuning parameters: 1) the terminal node size for the single tree, 2) the number of trees, and 3) the proportion of predictors to be sampled. These tuning parameters can be chosen following a similar cross-validation scheme as described in the previous subsection. Following the conventional settings, a value of 5 was used for the terminal node size, the number of trees set to be 10,000, and the proportion of the features selected in each subsample set to be ⅓ in the exemplary analysis.

Boosting method assigns observations responsible for highly localized features more weight in the fitting procedure. After a large number of iterations, by giving relatively more weight for the difficult-to-fit observation, one can combine the predictions from each iteration in a sensible way to reduce over-fitting. In the present example, a specific approach called stochastic gradient boosting was used to estimate the complex regression function

$${G}_{t \to t + F}^{L R} ( \cdot )$$

in model (1). The minimum number of observations in the terminal node was set to be 1 and sample all the observations employing a shrinkage parameter of 0.02. The interaction depth ranged from 5 to 15 based on five-fold cross-validation with the total number of iterations capped at 1,000.

The input features in model (1) can be grouped into three categories: the endogenous temporal features, the exogenous temporal features, and the spatial features. The endogenous temporal features are the lagged values of the response variables at location sᵢ which are included to capture the temporal effects of the response variable at location s; on the target location s₀. Using the endogenous along without the other two types of input features, the model reduces to a traditional time series model if the target location is also sᵢ. The exogenous temporal features are extra (idiosyncratic) variables other than the response variable that are collected at location sᵢ up to certain lags to the past because the target weather variable may be influenced by many other weather variables as well.

The endogenous temporal features are same as the response variable which depends on the specific research interest. In the present example, the temperature was used as the response variable and as the endogenous feature because it plays a determinant role in building energy simulation. The choices of the exogenous temporal features depend on the availability of the data collected from the PWSs. In the present example, the variables denoted by “input” in Table 2 were used as the initial set of endogenous features since they are collected at each PWS. It is also conceivable that not all the endogenous temporal features are indeed useful in predicting the response variable in the future time. Including irrelevant features not only introduce additional biases in the model estimation but also significantly increase the unnecessary computation burden. Hence, a practical variables selection procedure may be used to identify the set of relevant features. More details about the variable selection procedure is provided herein.

TABLE 2
Model response and input features in the case study

| Feature | | |
|---|---|---|
| Name | Description | Role |
| tempAvg | Temperature average of the period | Response |
| dewptAvg | Average dew point of the period | Input |
| heatindexAvg | Heat index average of the period | Input |
| humidityAvg | Average Humidity of the period | Input |
| precipRate | Rate of precipitation | Input |
| precipTotal | Accumulate Rain for the day in defined unit | Input |
| | of measure | |
| pressureMax | Highest Barometric pressure in defined unit | Input |
| | of measure of the period | |
| pressureMin | Lowest Barometric pressure in defined unit | Input |
| | of measure of the period | |
| pressureTrend | Pressure tendency over the preceding period | Input |
| uvHigh | Highest UV Index of the period | Input |
| windchillAvg | Windchill average of the period | Input |
| winddirAvg | Wind direction average of the period | Input |
| windgustAvg | Wind gust average of the period | Input |
| windspeedAvg | Wind speed average of the period | Input |

The spatial features contain information of spatial relevance of location sᵢ to the target location s₀. They are included to capture the spatial impact of target location form surrounding locations. A common choice of the spatial feature is the geo-distance, d(sᵢ, s₀), between sᵢ and s₀. However, in the present example, the relative differences in latitude and longitude, δ^{lon}(sᵢ, s₀) and δ^{lat}(sᵢ, s₀), were used to allow machine learning models capture more complex spatial relationship than a linear relationship induces by the geo-distance. Note that, δ^{lon}(sᵢ, s₀) and δ^{lat}(sᵢ, s₀) provide more information than d(sᵢ, s₀) because for any two locations sᵢ and sⱼ, if δ^{lor}(sᵢ, s₀)=−δ^{lon}(sⱼ, s₀) or δ^{lat}(sᵢ, s₀)=δ^{lat}(sⱼ, s₀), then one always has d(sᵢ, s₀)=d(sⱼ, s₀).

Besides choosing a specific model form for

$${G}_{t \to t + F}^{L R} ( \cdot ) ,$$

the parameters F, L and R need to be determined corresponding to the chosen model. The choice of F solely depends on the demand of when the future weather forecast is needed. For example, with a 15-minute model resolution, the predictive model for making a one-day ahead forecast corresponds to F=96.

The value of Z determines how far back to the past input features are fed to the model. For example, with a 15-minute model frequency, setting L=192 allows the model to use historical weather variables up to two days prior to the present time t where the forecast is made. The appropriate value for L can be determined by carefully assessing the auto correlation function (ACF) plot to see how strong the temporal association is among the weather variables. Alternatively, one can also adopt a cross-validation approach to choose the optimal value for Z that minimizes the prediction error. In this way, the selected optimal value Z can shed light on the temporal dependence of the response variable from the input weather variables.

The parameter R restricts the model structure to be the same within the neighborhood of the target location. In general, a larger value of R allows to use more data from the neighboring PWSs in training but imposes a more stringent assumption on the model. Similar to selecting the optimal value for L, one can follow a cross-validation approach to select the optimal value for R for gaining insights on the spatial dependence of the response variable on the input weather variables. Details on how the selection of optimal values for L and R is implemented is provided herein.

The spatial-temporal model equipped by random forest (RF) using weather data collected by PWSs located in the city of San Antonio, Texas was to demonstrate the implementation of platform 10. Temperature was selected as the response variable as it is most important weather input for building energy simulation. The forecasting accuracy was compared with existing benchmark methods to illustrate the usefulness of the model.

Data was are obtained from the Weather Underground (WU) Rapid Historical Observations API service which supplies the high-frequency (at a roughly 5-minute interval) weather information collected by PWS over the city of San Antonio, TX. The available fields for WU API data collection are known in the art. For a typical day, on average, there are around 300 PWSs reporting weather data to WU on a voluntary basis. Since the data reporting process from PWSs are voluntary and the availability also depends on the functional and network status of the device, not all the listed fields are reported for all time points by all PWSs. Therefore, the number of available stations by the time when the data are collected may vary from one time point to another. In addition, some stations contain missing values for some data fields during periods when data were collected due to various reasons, such as connectivity issues. A typical imputation approach was used to impute the missing values through interpolation using adjacent available value in time and location. There are also measurement errors and outliers in the collected weather data. To ensure the model accuracy and reduce noises in the training data, each observation was assessed to filter out the erroneous data values or impute them with more reasonable values. A detailed description of how data was collected and prepared is provided herein.

To demonstrate the advantages of the proposed model for platform 10, its performance was comparted to some commonly used weather forecasting methods in the literature. Typically, when the crowdsourcing data are not available, temperatures from public weather sources (e.g., airports) are usually used. One limitation of using the airport temperature is that most available data of airport temperature is at hourly or coarser frequency which may potentially miss the rapid changing patterns of the temperature within an hour. More importantly, airports are often located in suburbs area, where are far away from a target building in most cases. In addition, for most buildings, the airport is located at a very distant location of which the temperature may be different from the target location. In this example, the temperature forecasts at airport provided by NOAA are denoted by Ŷ_{airport,t+F}, which predicts temperatures in 1-hr-ahead forecasting up to 24-hr-ahead forecasting depending on F. Details of NOAA forecasts data are provided herein.

Persistence models are also widely used in the literature as a “model-free” approach to forecast the future temperature. One of the simplest persistent models is to assume that the forecasted temperatures are the same as the temperature 24 hours ago at the target location. Thus, the persistent model could be also called the “Like-Yesterday Model”, which is denoted as

$${\hat{Y}}_{{s}_{j} , t + F}^{persist}$$

in this study. In this example, if one observes Yₛ_{ⱼ}_{,t} for the j-th PWS, one can forecast the future temperature at sⱼ as

$${\hat{Y}}_{{s}_{j} , t + F}^{persist} = {Y}_{{s}_{j} , t + F - 96} .$$

However, the proposed framework for platform 10 is for making a forecast at arbitrary location s₀ which may not necessarily be a location where historical observations are available. Hence, the traditional persistent model may be modified using the similar approach discussed herein. That is, the local forecasts from each PWS are combined using the persistence model

$${\tilde{Y}}_{{s}_{0} , t + F}^{persist} = {\sum }_{j = 1}^{R} ( {ω}_{j} \times {\hat{Y}}_{{s}_{j} , t + F}^{persist} ) , \qquad ( 6 )$$

where

$${ω}_{j} = \begin{matrix}1 / d ( {s}_{0} , {s}_{j} ) \\ {\sum }_{j = 1}^{R} ( 1 / d ( {s}_{0} , {s}_{0} ) )\end{matrix} .$$

Note that, if the on-site historical observations are available for the target location So, one can directly use the persistence model forecast as

$${\hat{Y}}_{{s}_{0} , t + F}^{persist} = {Y}_{{s}_{0} , t + F - 96} .$$

To evaluate the forecasting accuracy and compare between different methods, it possible to use the mean absolute percentage error (MAPE):

$$MAPE = \frac{1}{n} {\sum }_{i = 1}^{n} \frac{\vert {\hat{Y}}_{i} - {Y}_{i} \vert}{{Y}_{i}} \times 100 \% , \qquad ( 7 )$$

where Ŷᵢ's are the forecasted values, Yᵢ's are the observed values of the response variable, and n is the total number of evaluated data points.

In this example, the forecast resolution was set to be every 15 minutes. Following the model framework and implementation procedure described above, the optimal model parameters were identified and the best subset of input features selected to be used for a selected period. Then, the optimal model was used to make temperature forecast at an arbitrary located building, San Antonio Technology Center (SATC), where the temperature is measured at every 15 minutes frequency when available.

In practice, historical observations may not be available at the target location. In such a case, it is possible to identify the optimal model parameters and select the best subset of input features based on the weather variables collected at surrounding PWSs such that the trained model would capture the most characteristics of the target station according to the weather information from the closest neighboring PWSs. Therefore, to keep the generality, the closest PWS to SATC were selected according to the station availability in different seasons and treat it as the target location for model parameters selection. In this way, it is possible to identify the optimal parameters and the set of input features that produce the best out-of-sample forecast accuracy for the target station. If historical data are available at the target location, the target location can be viewed as a PWS so that more direct information can be utilized. With the identified optimal parameters, the model performance may be evaluated during selective 8-day periods of different seasons which are summarized in Table 3 in chronological order of when the data were collected.

TABLE 3
Selected periods and target stations at different seasons

| Season | Target PWS ID | Period |
|---|---|---|
| Spring | KTX1108 | 2020 Mar. 28~2020 Apr. 4 |
| Summer | KTX871 | 2020 May 20~2020 May 27 |
| Fall | KTX1530 | 2020 Oct. 1~2020 Oct. 8 |
| Winter | KTX1530 | 2020 Dec. 2~2020 Dec. 9 |

As noted above, the local forecast model structure depends on the size of the neighboring R PWSs surrounding the target location, and the temporal lags Z of weather input features that are predictive for the future temperature. As part of the optimal parameter identification process, different choices of rolling window size W were considered to see how much additional data are needed to improve the forecasting accuracy and evaluate the persistence of the model structure.

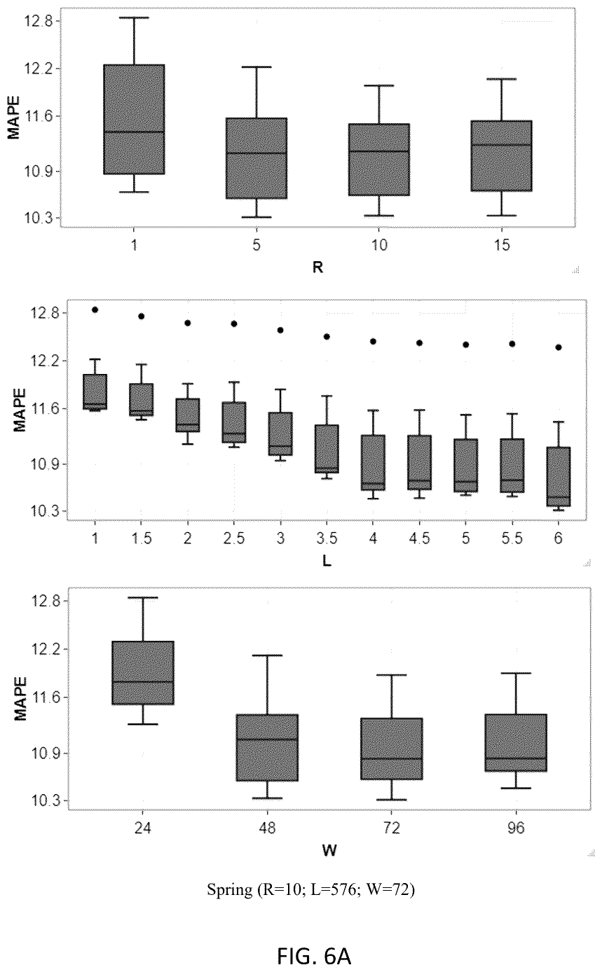

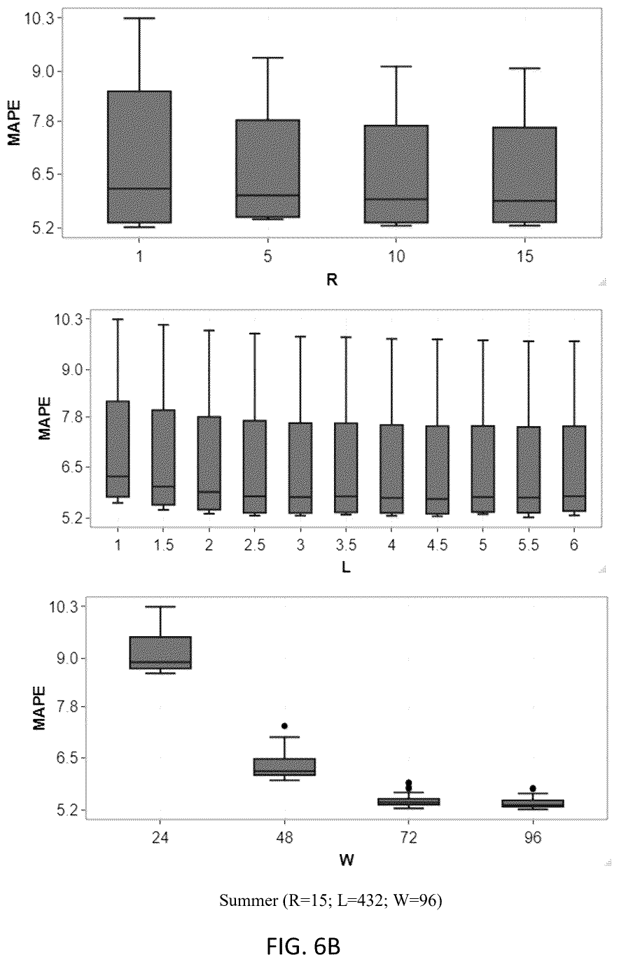

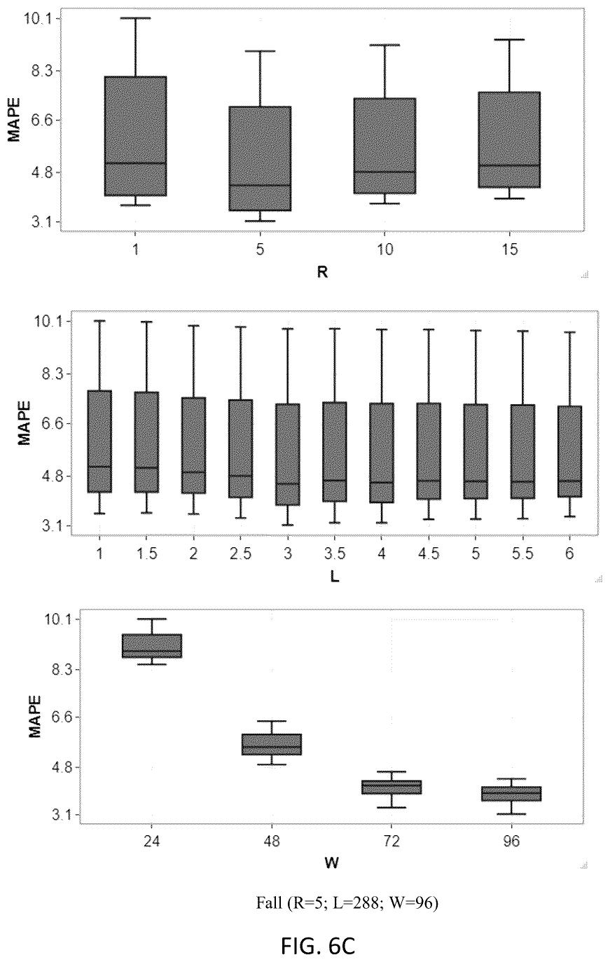

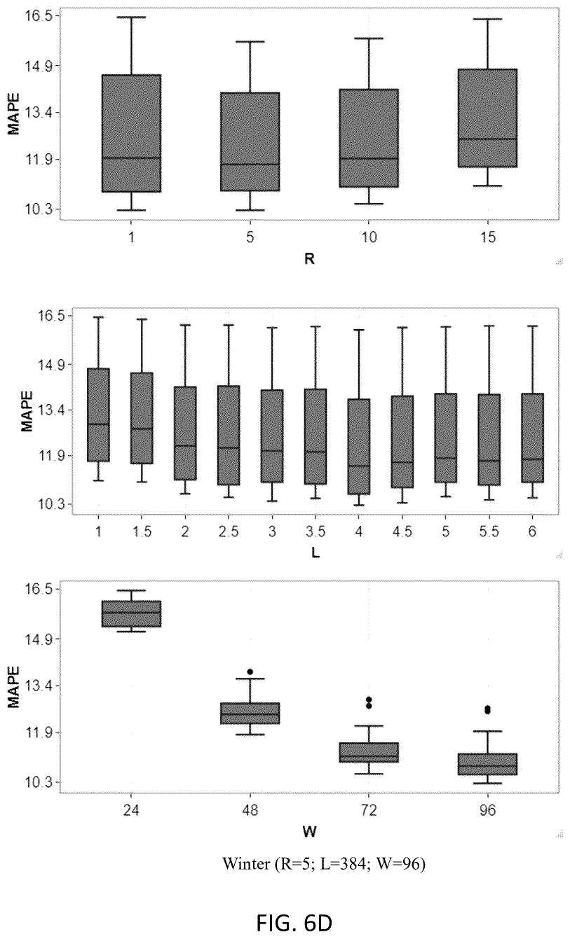

Referring to FIGS. 6A through 6D, the performance of the RF model during the evaluation periods at different seasons using different values of the model parameters is shown. The left, middle, and right plots present results of the distribution of MAPE for different values of R, L, and W respectively over different choices of other model parameters. For example, the left figure presents the average MAPE over different choices of L, W, and F given different values of R. Each boxplot represents a conditional distribution of MAPE for a given value of single model parameter over other model parameters.

In FIGS. 6A through 6D, each season is commented with the optimal parameters R, L and W in the parentheses that are selected according to the lowest MAPE across other parameters. The optimal value of R suggests that the effective size of the neighborhood is to include 5 to 15 PWSs around the target location to forecast the future temperature. The evident improvements from R=1 indicate that including crowdsourcing data around the target location is useful compared with using only the on-site weather data at a single location. The temporal lags of the input features around 4 days prior to the time when the forecasts are made are sufficient to build a reliable forecasting model. Finally, the most significant gains in MAPE are observed of having a rolling window to be 18 hours or 24 hours indicating that the modeling structure and parameters can roughly last during a 24-hour time span. With the computation time in mind, W=72 or 96 was chosen for the forecasting model at a 15-minute frequency.

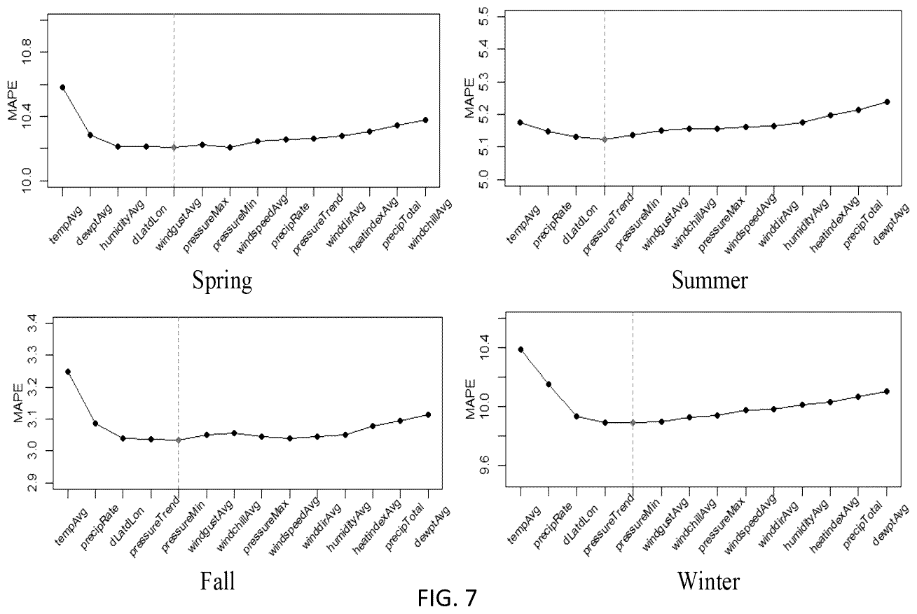

Once the optimal parameters are identified, a forward-selection procedure is used to obtain the optimal set of the model input features. To implement the procedure, one begins with building the forecasting models using a single weather variable. The single feature that performs the best according to the average MAPE is selected, and an additional feature to pair with the selected feature is added in the second step to train two-feature forecasting models. Then, the second weather input feature is selected by choosing the feature that produce the best performance being paired with the selected feature in the first step. This process is carried on until all features are sequentially included in the model. From FIG. 7, the order of the features is shown as the horizontal axis, and it may be seen that for different seasons, different sets of weather variables are included in the optimal set. However, tempAvg and dLatdLon seem to be the most import predictive features in all seasons, which means that the temporal and spatial information are crucial at most time, and dewptAvg, humidityAvg, windgustAvg, precipRate, pressureTrend, pressureMax, precipTotal, windchillAvg, and heatindexAvg are also found useful to further improve the forecasting accuracy depending on the season. If the model performs as well as a full fed of features input, then fewer inputs could be used for computing efficiency. Ultimately, the first few features up to the red-marked variable in FIG. 7 are the selected optimal feature sets for temperature forecasts model.

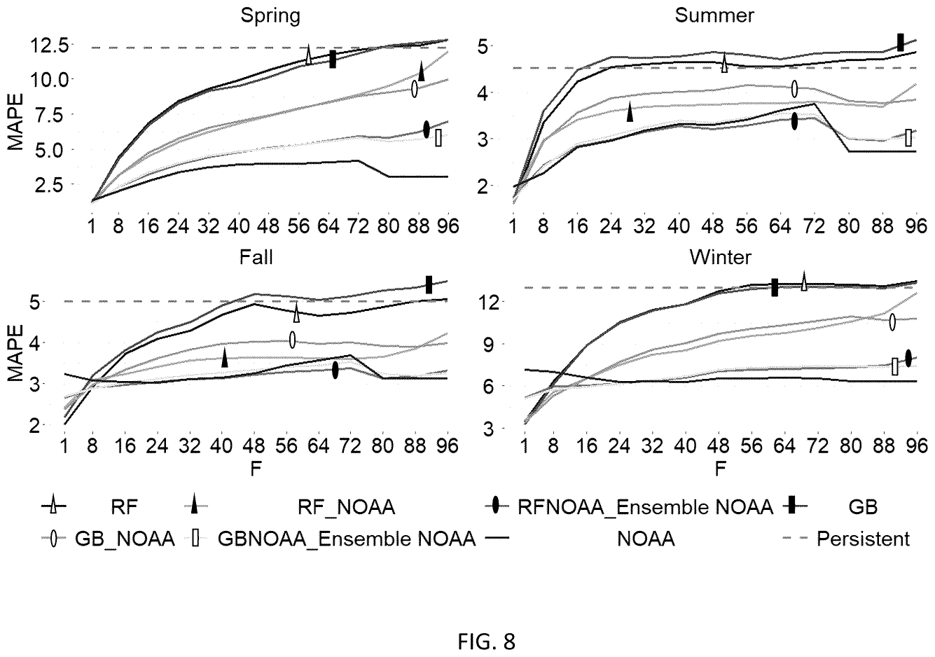

Using the model with optimal parameters, the performance is first validated by making weather forecasts for the same target PWSs mentioned in Table 3, but as an arbitrary location. This means that, the actual weather information of the target PWSs are pretended to be unknown such that the first station included as the neighboring stations according to the R parameter starts from the closest PWS instead of the target PWS. Since a unique set of optimal parameters have been settled for each season, the computing speed would be much faster than the model validation process. Thus, the forecasts performance were performed in a longer period as shown in Table 4 to evaluate the assumption that the model would hold in each season with corresponding optimal parameters and feature sets selected in FIGS. 6A through 6D and FIG. 7. Using the forecasts of airport temperature and the persistent model described above as benchmark models, the average MAPE of the RF model using the proposed framework during the evaluation periods of different seasons is shown in FIG. 8. The average MAPE is calculated for different forecasting horizon F up to 24-hour-ahead (F=96).

TABLE 4
Selected forecasts period for arbitrary stations at different seasons

| Season | Forecasts Period |
|---|---|
| Spring | 2020 Mar. 20~2020 Apr. 4 |
| Summer | 2020 May 20~2020 May 27 |
| Fall | 2020 Oct. 1~2020 Oct. 8 |
| Winter | 2020 Dec. 2~2020 Dec. 9 |

Each line in FIG. 8 represents MAPE performance of its corresponding model at different forecasting horizon F. RF_NOAA represents the random forest model with NOAA airport forecast as feature input and RFNOAA_Ensemble NOAA is random forest model with NOAA as feature input and further ensemble with NOAA airport forecast. The notation works similar for gradient boosting method. Compared with the persistent model (green dashed line), the proposed model demonstrates evident advantages for most/values as majority part of each line are below the green dashed line. For the forecasts when F is large and close to one-day ahead forecast, the proposed model performs similarly to the persistent model. This is expected due to the daily seasonality of the temperature, while the persistent model is always taking yesterday's temperature. Comparing the overall average MAPE, the proposed model performs better in summer and fall, compared with spring and winter. This is due to the stability of the temperature in San Antonio during the evaluation periods. Hence, the time-series of the forecast and the observed temperature are inspected at the target PWSs during each season.

In terms of different machine learning methods, random forest slightly outperforms the gradient boosting model with or without including NOAA airport forecast features for most forecasting horizon F through all four seasons. For instance, the light orange line, RF_NOAA, is below the light blue line that is corresponding to GB_NOAA for most Fs in summer except for F greater than 80.

In fact, these target PWSs locate about 5 miles away from the airport location, where the actual temperature may only have minor differences with the temperature at the target PWSs. Since the airport forecasts is retrieved from the NOAA, it has relatively matured and high-performance model. The model framework has been significantly improved when including the airport forecasts as the model inputs for all seasons, and by averaging with the airport forecasts, the accuracy could be further improved especially for larger forecasting horizon F. Although, the model did not demonstrate an advantage over NOAA airport forecasts here, the scenario where the model outperforms NOAA airport forecast is discussed herein.

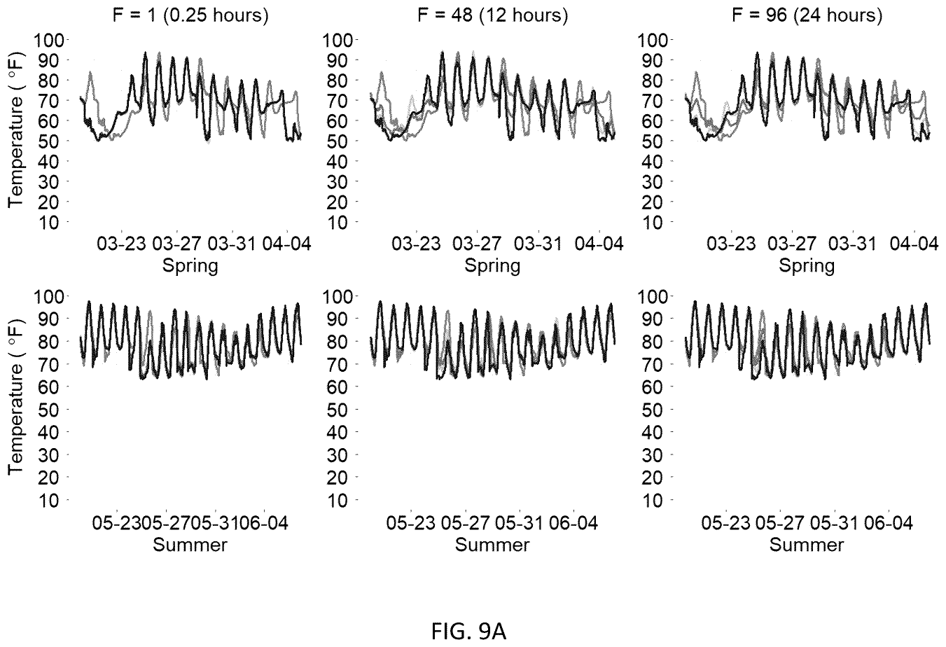

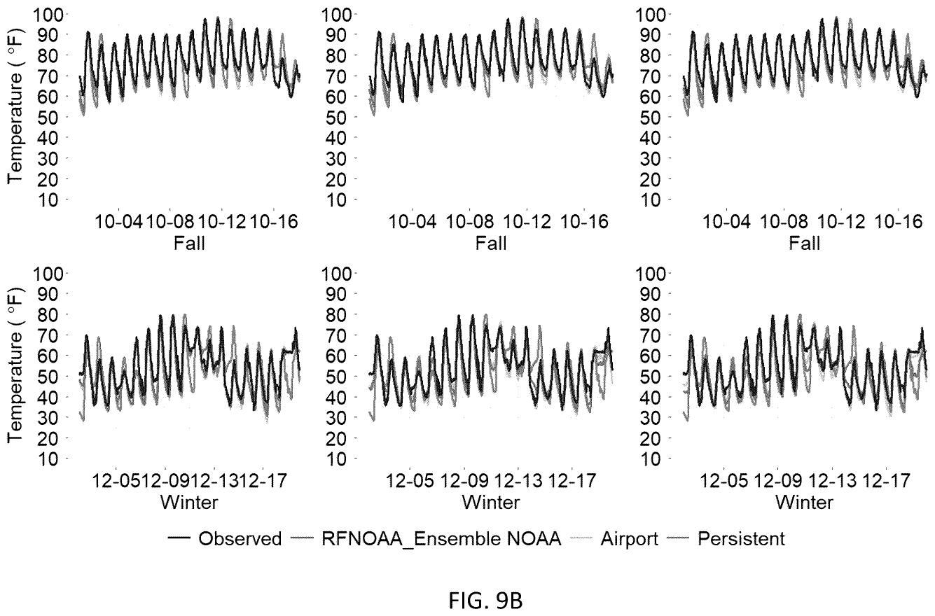

FIGS. 9A and 9B show a time series plot for the observed temperature and forecasting temperature from different models for different forecast horizon F (F=1, 48, and 96) in all four seasons. The “Airport” here is NOAA airport forecast mentioned above. The temperatures in San Antonio in summer are more stable compared with other seasons. The selected periods in all other seasons include abnormal days that the daily seasonal patterns are distrusted. This caused the deterioration of the overall model performance, especially for spring and winter showing in FIG. 8. Nevertheless, the proposed model still outperforms the persistent models for any F before 16 consistently, and the model is even better when including more accurate airport forecasts information. The average MAPE at different look-ahead time by different models are reported in Table 5 and the lowest MAPE for each selected F is highlighted in bold.

Based on Table 5, the proposed model framework is able to outperform the persistent model by a lot of margins. For example, the mean of MAPE for persistent model is 12.21 through all forecasting horizon F in Table 7 but RFNOAA_EnsembleNOAA is 4.21, which implies a 65% of improvement. In addition, similar to finding of FIG. 8, the proposed model framework demonstrates an advantage in short-term forecast, where F is smaller than 24 (equivalent to four hours) as most bold numbers are from proposed model framework when F is small. For instance, in winter MAPE of RF is 3.44 while 7.12 for NOAA airport forecast, which represents a 51.68% improvement. The improvement in short-term forecast compared with our bench model NOAA airport forecast is significant for building control load forecast as the system mostly used temperature forecasting results range from F=1 (15 minutes ahead) to F=24 (six hours ahead) forecasts as inputs. In general, the proposed model framework in summer, fall and winter in terms of mean but not in spring. The reason can be found in FIGS. 9A and 9B, where there is an abnormal temperature pattern occurring in spring that may adversely affects the forecasting accuracy.

TABLE 5
Model performance (MAPE) at selected look-ahead windows

| Season | Model | F = 1 | F = 8 | F = 24 | F = 48 | F = 72 | F = 96 | Mean |
|---|---|---|---|---|---|---|---|---|
| Spring | Persistent | 12.21 | 12.21 | 12.21 | 12.21 | 12.21 | 12.21 | 12.21 |
| | Airport | 1.31 | 2.00 | 3.33 | 3.96 | 4.16 | 3.04 | 2.97 |
| | RF | 1.13 | 4.44 | 8.43 | 10.61 | 12.06 | 12.77 | 8.24 |
| | RFNOAA | 1.23 | 3.15 | 5.49 | 7.35 | 8.87 | 11.94 | 6.34 |
| | RFNOAA_EnsembleNOAA | 1.10 | 2.31 | 3.88 | 5.06 | 5.91 | 6.98 | 4.21 |
| Summer | Persistent | 4.52 | 4.52 | 4.52 | 4.52 | 4.52 | 4.52 | 4.52 |
| | Airport | 1.97 | 2.27 | 2.97 | 3.30 | 3.74 | 2.73 | 2.83 |
| | RF | 1.60 | 3.34 | 4.53 | 4.65 | 4.60 | 4.85 | 3.93 |
| | RFNOAA | 1.70 | 2.97 | 3.60 | 3.73 | 3.80 | 4.17 | 3.33 |
| | RFNOAA_EnsembleNOAA | 1.74 | 2.44 | 2.98 | 3.20 | 3.43 | 3.18 | 2.83 |
| Fall | Persistent | 5.00 | 5.00 | 5.00 | 5.00 | 5.00 | 5.00 | 5.00 |
| | Airport | 3.23 | 3.06 | 3.02 | 3.25 | 3.68 | 3.12 | 3.23 |
| | RF | 1.99 | 2.91 | 4.08 | 4.93 | 4.71 | 5.05 | 3.95 |
| | RFNOAA | 2.40 | 3.09 | 3.40 | 3.63 | 3.59 | 4.23 | 3.39 |
| | RFNOAA_EnsembleNOAA | 2.65 | 2.90 | 3.03 | 3.20 | 3.36 | 3.32 | 3.08 |
| Winter | Persistent | 12.96 | 12.97 | 12.97 | 12.97 | 12.97 | 12.97 | 12.97 |
| | Airport | 7.12 | 6.99 | 6.29 | 6.54 | 6.54 | 6.32 | 6.63 |
| | RF | 3.44 | 6.30 | 10.51 | 12.71 | 13.26 | 13.45 | 9.95 |
| | RFNOAA | 3.57 | 5.53 | 7.52 | 9.18 | 10.14 | 12.63 | 8.09 |
| | RFNOAA_EnsembleNOAA | 5.14 | 5.95 | 6.16 | 7.04 | 7.23 | 8.03 | 6.59 |

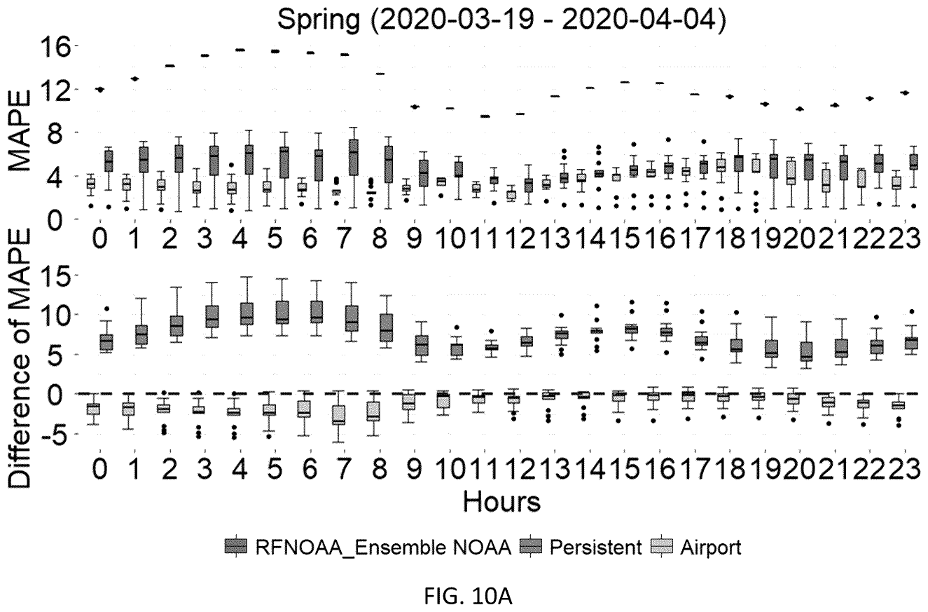

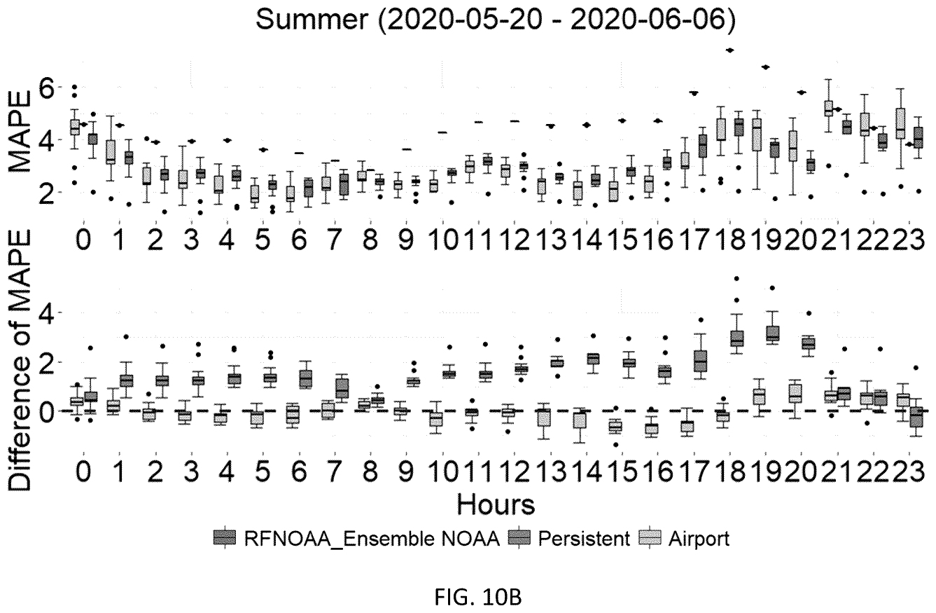

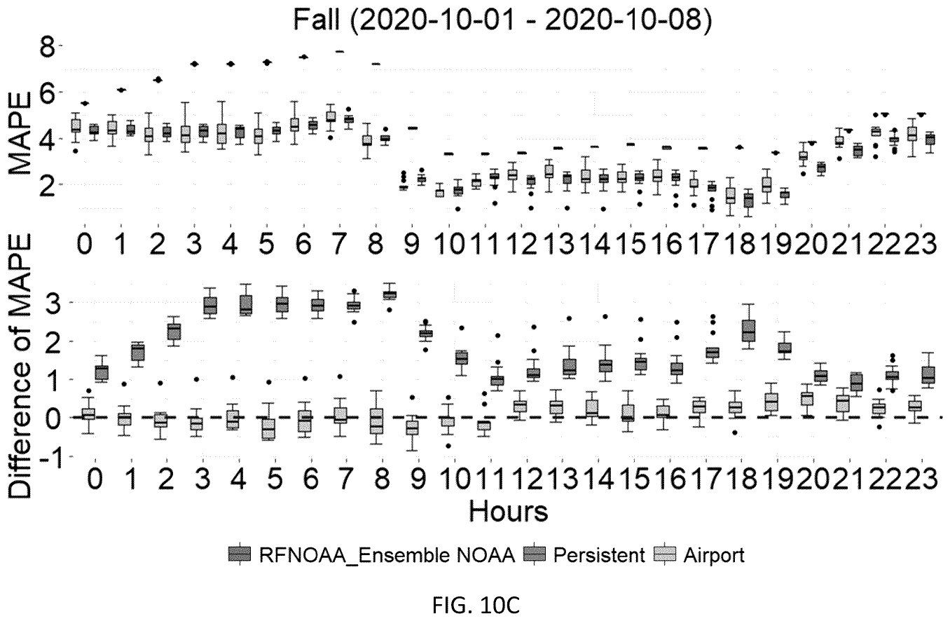

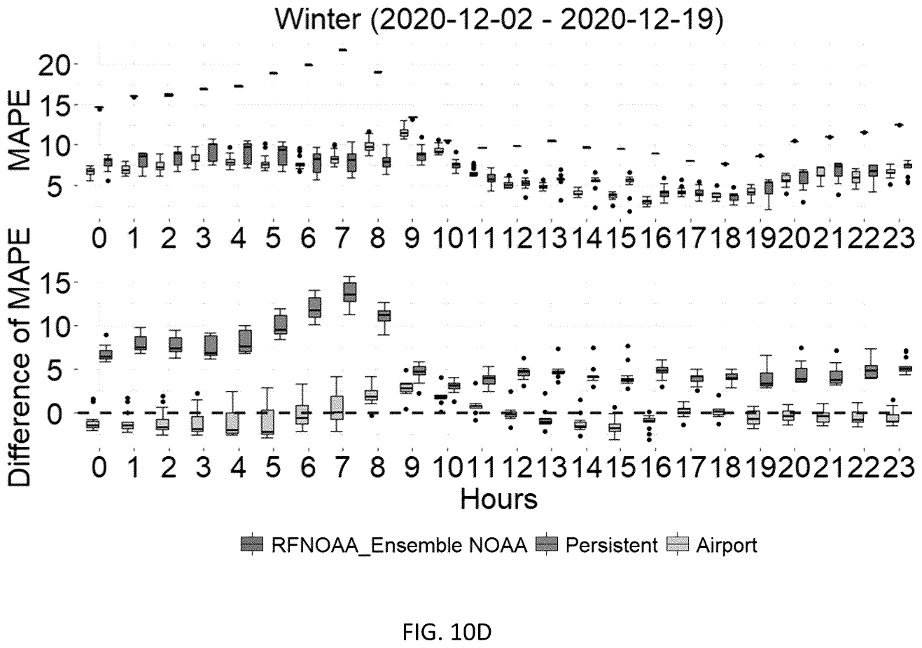

It is often of interest in building energy simulation to know during what hours of the day the weather forecasts are more reliable compared with others. For each season, two plots are presented in FIG. 10A through 10D. The top-panel plots compare the distribution of MAPE at different hour of the day by three models. It reveals the fact that the proposed RF model is much more stable (with a smaller range in boxplots) than the airport forecast and persistent model. To further assess the gain in forecast accuracy of the proposed model, the difference of the MAPE in the bottom-panel is plotted by subtracting MAPE of the proposed model from the MAPE of airport forecast and persistence model with corresponding look-ahead period accordingly. If the difference is above the 0-reference line, the proposed model demonstrates an absolute advantage of all look-ahead forecast horizon. As a result, a commonly observed pattern is that the proposed model almost consistently outperforms the benchmark models in almost all seasons except for winter where the proposed model may slightly under-perform from mid-night to the sunrise. The improvements are more significant in summer than other seasons.

Until this point, the model performance for the target PWSs was evaluated as an arbitrary station given that the target location has unknown weather information. Since the goal is to forecast the weather at the SATC location as mentioned above when selecting the target PWSs nearby the SATC, the model performance should be evaluated at the actual SATC location. However, due to the data availability, only observed temperatures for SATC building in 2019 were available to calculate the performance accuracy. Hence, the model framework would also be evaluated the assumption that it holds annually for the same seasons such that it possible to be applying the same optimal parameters and features set to forecasts temperatures in 2019. Since this project started collecting PWS temperatures from summer in 2019 and relatively less availability than the data collection in 2020, it is only possible to evaluate the SATC forecasts for summer, fall and winter in 2019, and the forecasting period for SATC is shown as Table 6.

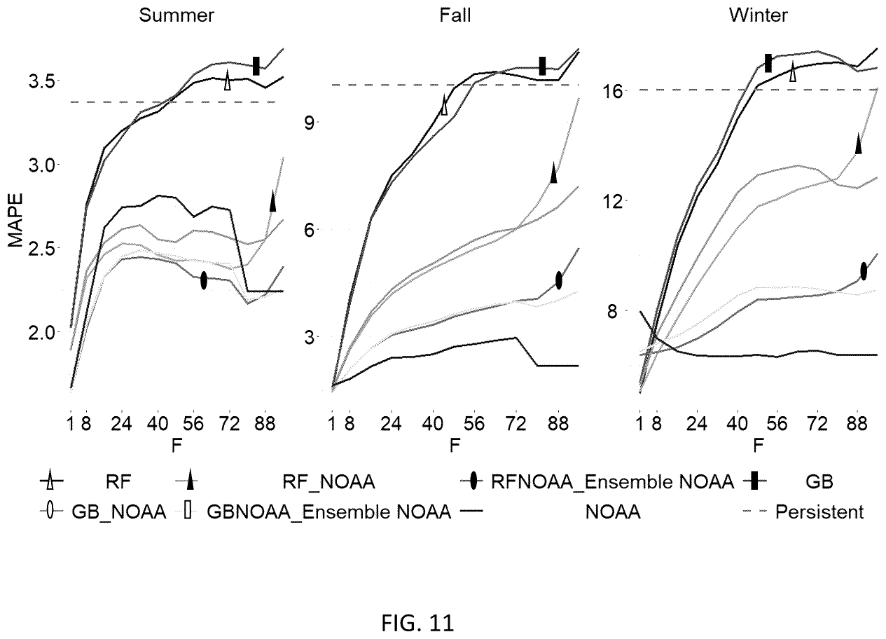

The forecasts performance for SATC location in 2019 is seen in FIG. 11. Similarly, the temperature in summer is relatively stable, and the model performance is promising to be improved by adding the airport forecasts information as part of the input.

TABLE 6
Selected forecasts period for SATC in 2019

| Season | Forecasts Period |
|---|---|
| Summer | 2019 May 24~2019 Jun. 7 |
| Fall | 2019 Oct. 3~2020 Oct. 15 |
| Winter | 2020 Dec. 3~2020 Dec. 20 |

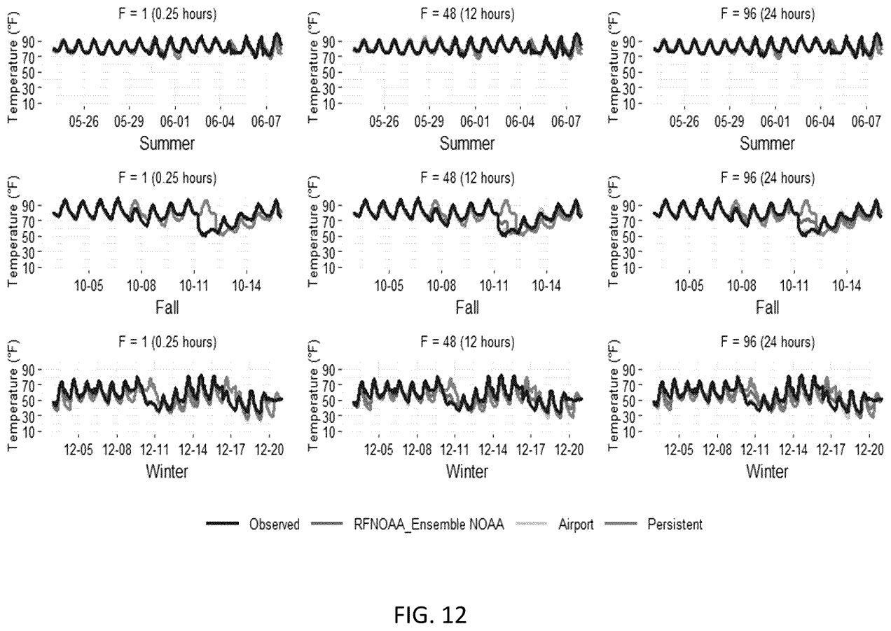

However, according to FIG. 12, when there is sudden change of temperature such as temperature suddenly dropped in a large amount after October 11th in fall, it significantly impacts the model's performance. Similar events happens between December 8th and December 11th in winter. This explains why the model underperforms NOAA airport forecasts in fall and winter.

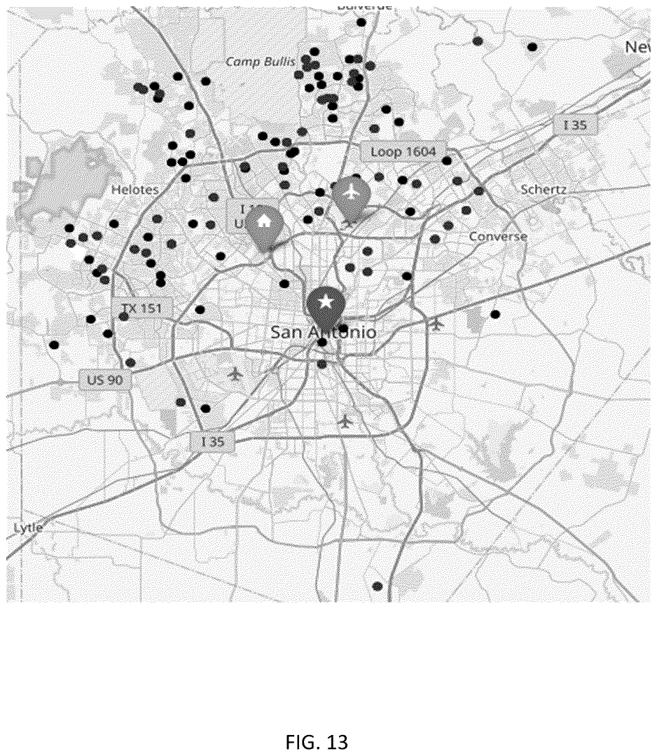

Even though the airport forecasts provided by the NOAA have been performed by a high-performance model, a single airport forecasts would be too broad to represent the temperatures for every station in the city. In the example, the target locations are not relatively far from the airport, and thus the model performances have not showed a significant advantage on the crowdsourcing weather data. Thus, the model implementation was extended for more target PWSs as the arbitrary locations and evaluate the forecasts performance at various locations within the city to compare with the airport forecasts. 50 PWSs scattered around the San Antonio area were selected, and these are always available to retrieve the observed temperature for the sake of calculating the forecasts accuracy. The rest of the settings are consistent with the study discussed above for four seasons. FIG. 13 is a map of the San Antonio marked with 50 selected target PWSs. The airport and SATC location are also labeled in blue icons.

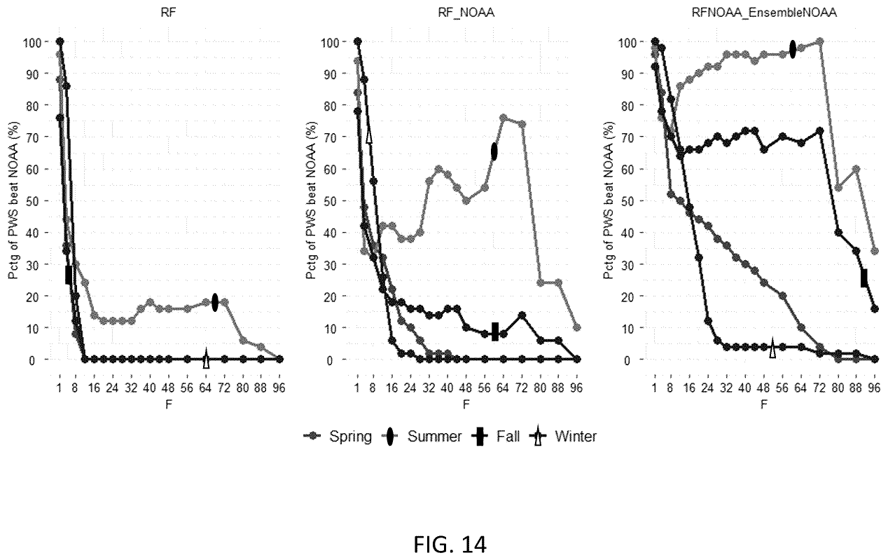

During the implementations for each target PWSs, all forecasts accuracy is calculated with MAPE. In a large-scale point of view, since it is desired to analyze the overall advantages of the model framework comparing with the airport forecasts, the number of the target PWSs that are outperformed the airport forecasts over various model methods are counted in FIG. 14. When the line is above 50, it implies that more than half of locations outperform NOAA airport forecast with the model in that season and vice versa. It is also clear that even the classic random forest (RF—the first plot on the left) can beat NOAA airport forecast in most locations through all four seasons when F is smaller than eight. Evolving the proposed model framework from with weather inputs to adding airport forecasts as inputs (RF_NOAA) and later ensemble with the airport forecasts (RFNOAA_EnsembleNOAA), the percentage of the target PWSs that has forecasts accuracy outperformed the airport forecasts has increased when F is greater than eight. In this case, including a promising external forecast into the model framework would significantly improve the forecasts performance, and the built-in parameters in our framework could further take the spatial and temporal advantages using crowdsourcing data from the PWSs nearby.

The model demonstrates clear advantages over forecasts made using airport temperature and persistence model. Generally speaking, the model framework equipped with random forest can improve forecasting accuracy by 50% compared with persistent model based on Table 5. Additionally, according to FIG. 8 and FIG. 11, the model framework equipped with random forest has approximately 90% chance to beat the airport forecast in short-term forecast (F smaller than eight-two hours ahead forecast) in any arbitrary locations of San Antonio and Syracuse through four seasons. Including the airport forecasts as model inputs and ensembling our forecasts with the airport forecasts can further improve the model's performance. In a real-time setting, the proposed model framework is able to provide more accurate temperature forecasting results regarding CoE building compared with using airport temperature forecast for most forecast horizon F. For instance, based on FIG. 8, the model using random forest machine learning method including NOAA airport forecast as feature inputs and ensembling with NOAA airport forecast outperforms airport forecast all the way until F=72 (18 hours). A 2-day temporal lag are found sufficient in capturing the association between the future temperature and historical weather data. When studying the effect of a rolling window, it was found that the model structure can hold last as long as eight weeks. Finally, tempAvg, humidityAvg, precipTotal, windchillAvg, pressureMin, dewptAvg, precipRate and pressureMax are found to be the most important features in predicting the future temperature and having additional features may negatively influence the model performance.

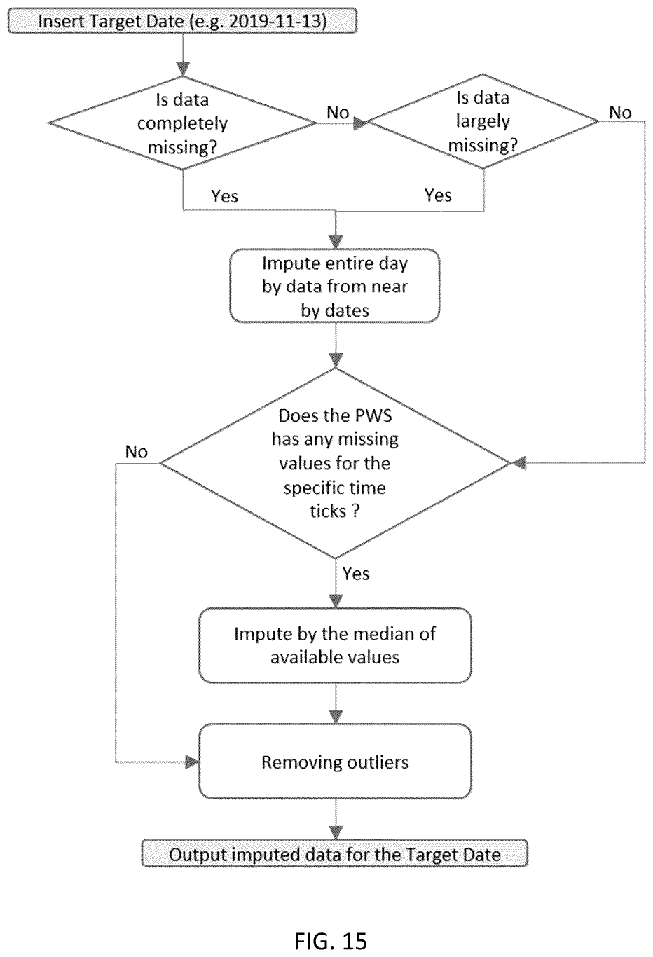

FIG. 15 shows the steps that followed to prepare a clean data for modeling. The first issue of the collected data from PWSs is the misalignment of time-ticks. Since the data from individual PWSs are uploaded to the server through the local network using different devices, there exists a large number of variations in the final time-ticks when the data are recorded to the server although the WU requires each PWS to report the weather data at a 5-minute frequency.

Since the forecasting is aiming to be under 5-minute frequency, which has a total 288 time-ticks for a day (from 00:00:00 am to 23:55:00 μm), each reported tick-tick was matched to the nearest whole 5-minute mark. For example, an observation recorded at 00:09:58 am is matched to the 00:10:00 am mark. If the raw time-tick is at the middle of two whole 5-minute time-ticks (e.g., 03:02:30 am), it is rounded to the previous exact 5-minute mark (e.g., 03:00:00 am). If two raw time-ticks (e.g., 03:02:36 am and 03:07:17 am) are rounded to the same exact 5-minute mark, then it was possible to record the average of the two observations for the matching 5-minute mark.

TABLE 7
Example of time-tick matching

| Raw | Formatted |
|---|---|
| 04/29/2020 00:04:57 | 04/29/2020 00:05:00 |
| 04/29/2020 00:09:58 | 04/29/2020 00:10:00 |
| 04/29/2020 00:14:57 | 04/29/2020 00:15:00 |
| 04/29/2020 00:19:57 | 04/29/2020 00:20:00 |
| 04/29/2020 00:22:30 | 04/29/2020 00:20:00 |

There are two scenarios to be considered when dealing with the missing values in the data. First, a check whether the data are completely missing or missing at a significant portion (e.g., over 70% of data are missing). In this case, the quality or reliability of the data for that date may be questionable. Hence, it was possible impute the missing data or replace the small portion of the observed data (which might be of poor quality) by the complete data from the dates that are closest to the missing date. It was possible denote the data to be imputed at time t on certain date k by [symbol] _{k,t}, the complete data at time t on date k, by [symbol] _{k*,t}, where k, is the most recent date before date k that the complete data is available, and the complete data at time t on date k* by [symbol] _{k*,t}, where k* is the most recent date after date k that the complete data is available. Then, it was possible impute the missing data at time t on date k as

$${𝒟}_{k , t} - \frac{{δ}_{1}}{{δ}_{1} + {δ}_{2}} {𝒟}_{k , t} + \frac{{δ}_{2}}{{δ}_{1} + {δ}_{2}} {𝒟}_{{k}^{*} , t} ,$$

where δ₁=k−k, and δ₂=k*−k. After imputing the dates with complete or large missing values, the missing values at a local scope are dealt with next. In this stage, the missing values may occur at different weather stations and at different time ticks. Since the imputation at this stage will focus on a specific PWS, the data at time t is denoted on certain date k for j-PWS by [symbol] _{k,t}(sⱼ). It was possible to impute the missing data as

$${𝒟}_{k , t} ( {s}_{j} ) = median {𝒟}_{k , t} ( {s}_{i} ) for i \neq j and {𝒟}_{k , t} ( {s}_{i} ) is not missing .$$

Finally, the collected data may contain some abnormal values for weather variables (e.g., 130° F. for temperature) due to the defectiveness of the device or other issues. Hence, in order avoid the impact of these erroneous values in the modeling process, the tail 2.5% values of any weather variables are truncated. That is, for any weather variable X, if

$${X}_{k , t} ( {s}_{i} ) < {τ}_{k , t}^{0.025}$$

is set at

$${X}_{k , t} ( {s}_{i} ) = {τ}_{k , t}^{0.025} ,$$

and if

$${X}_{k , t} ( {s}_{i} ) > {τ}_{k , t}^{0.975}$$

it is possible to set

$${X}_{k , t} ( {s}_{i} ) = {τ}_{k , t}^{0.975}$$

where

$${τ}_{k , t}^{0.025} and {τ}_{k , t}^{0.975}$$

are the empirical 2.5^{th} and 97.5^{th} percentile of the weather variable X at time t on date k over all PWSs where data are not missing.

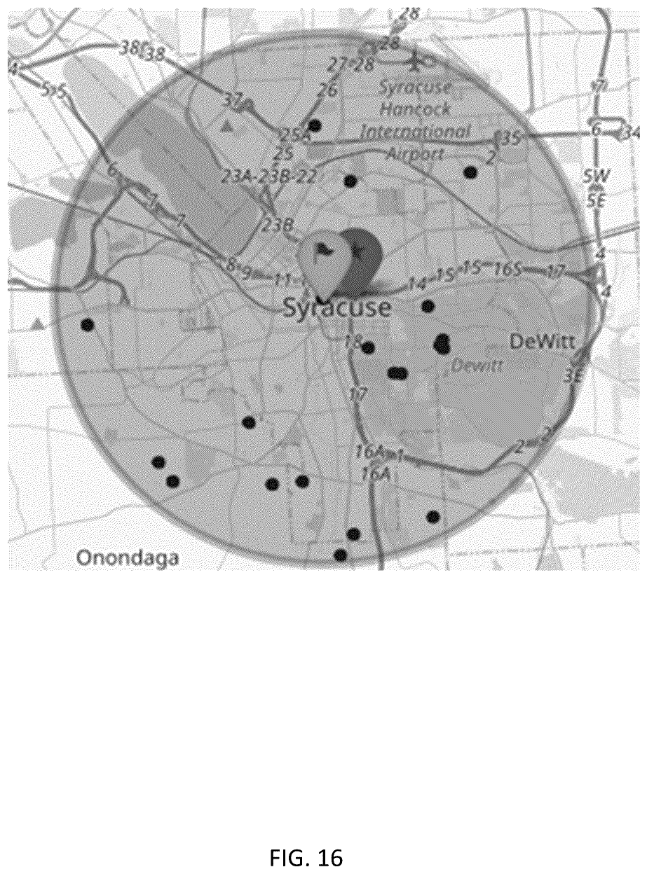

The data collected through the personal weather stations are uniformly close to each other within a certain range due to the nature of weather. For instance, FIG. 16 shows the CoE building in Syracuse (red star icon) with closest PWS to CoE (yellow flag icon). Blue points represent the closest 20 PWSs to the one that is closest to CoE with the average distance of 3.12 miles.

Table 8 shows the pearson correlation between each station and the closest PWS to CoE in the winter period. Each column represents a PWS (R1, R2, . . . , R15 is the ranking in terms of geo distance to the closest PWS) and each row is different forecast time horizon with F=0 (true temperature), F=8 (two hours ahead), F=48 (12 hours ahead), and F=96 (24 hours ahead). As the table shows, the recorded temperature of PWS is highly correlated to each other as the correlation values are all closest to one in the first row. This may adversely affect the forecasting model using data from PWS because temperature data from extra PWS will not provide more information regarding the temperature in that area.

TABLE 8
Correlation table

| F | R1 | R3 | R4 | R5 | R6 | R7 | R8 | R9 | R10 | R11 | R12 | R13 | R14 | R15 |
|---|---|---|---|---|---|---|---|---|---|---|---|---|---|---|
| 0 | 1.00 | 0.97 | 0.99 | 0.99 | 0.98 | 0.99 | 0.98 | 0.99 | 0.99 | 0.94 | 0.98 | 0.95 | 0.98 | 0.98 |
| 8 | 0.97 | 0.96 | 0.97 | 0.97 | 0.97 | 0.98 | 0.97 | 0.97 | 0.97 | 0.93 | 0.96 | 0.95 | 0.97 | 0.98 |
| 48 | 0.72 | 0.79 | 0.70 | 0.73 | 0.68 | 0.72 | 0.68 | 0.70 | 0.70 | 0.69 | 0.67 | 0.64 | 0.75 | 0.79 |
| 96 | 0.67 | 0.71 | 0.64 | 0.65 | 0.62 | 0.65 | 0.62 | 0.67 | 0.64 | 0.65 | 0.62 | 0.58 | 0.67 | 0.70 |

Besides collecting weather data from PWSs, historical and real-time weather forecasting data was collected from the NOAA as the model's benchmark and the feature inputs. NOAA's weather forecasting data is obtained from their High-Resolution Rapid Refresh (HRRR) model, which provides detailed forecasts of severe weather events such as temperature and atmosphere in the contiguous United States for next 18 hours (f=00, 01, . . . , 17, 18) with 15 minutes resolution and HRRR model runs on an hourly cycle at 00Z, 01Z, . . . , 22Z, 23Z (coordinate universal time). In this section, the step-by-step process of preparing historical weather forecasting data from NOAA's HRRR model is explained.

The first step is to download data files needed for the target period. NOAA stores their weather forecasting data generated by the HRRR model in grib2 file format, a binary file containing gridded meteorological data. Each individual grib2 file can be retrieved through curl command from NOAA's Amazon AWS cloud source. For instance, the following command code can be used to download the historical weather forecasting data for next one hour (f=01) at 1 a.m. (t=01Z) on Jan. 1, 2020 in the contiguous United States:

curl https://noaa-hrrr-bdp-
pds.s3.amazonaws.com/hrrr.20200101/conus/hrrr.t01z.wrfsubhf01.grib2 --output
20200101_hrrr.t01z.wrfsubhf01.grib2

(Note: use cd command to change the directory to desired folder for storing data before downloading)

The next step is to configure wgrib2 that is commonly used for retrieving data from grib2 file. To download wgrib2, it is possible to the link <<ftp://ftp.cpc.ncep.noaa.gov/wd51we/wgrib2/Windows10/>> (open the link through Internet Explorer) and then copy the (version)/*.dll and (version)/wgrib2.exe files to the directory where our grib2 files are stored.

After configuring wgrib2 into a data directory, it was possible to retrieve weather forecasting data based on one target location with its latitude and longitude from the grib2 file. For instance, one can use the following code to generate the weather forecasting data around San Antonio International Airport (29.5312°N,-98.4683°W) for next one hour (f=01) at 1 a.m. (t=01Z) Jan. 1, 2020: wgrib2 Data_Dir\20200101_hrrr.t01z.wrfsubhf01.grib2-undefine out-box-98.48: −98.44 29.43:29.63-csv

Data_Dir\subset 20200101_hrrr.101z.wrfsubhf01.csv

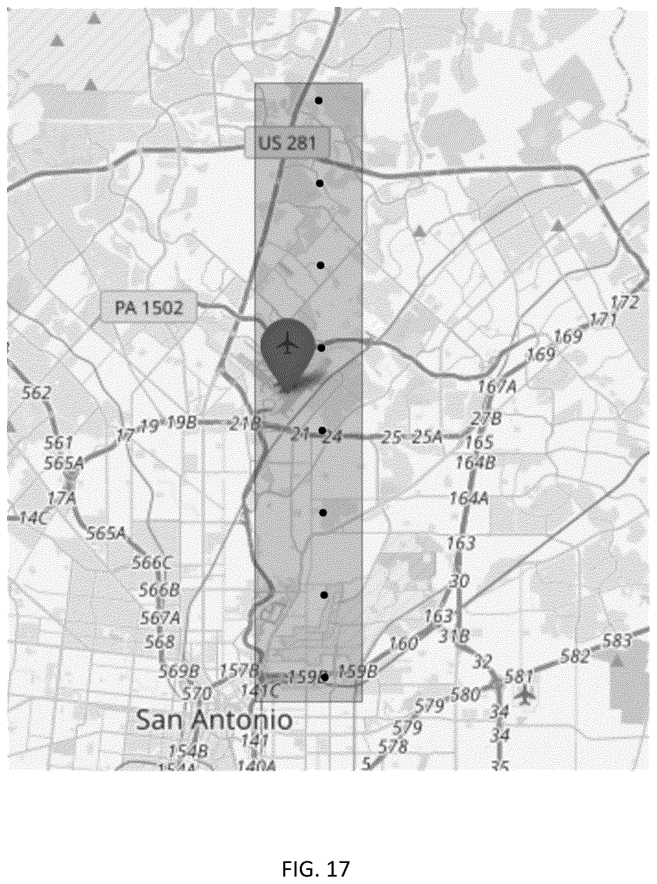

The code on the above will draw a rectangle centering around San Antonio International Airport (red plane marker) shown as FIG. 17. All weather forecasting data from locations represented by grid points (black dots on the map) within this rectangle will be retrieved from grib2 file.

Table 9 is a data dictionary for NOAA data and some variables are measured at different height levels e.g., there are surface level, 2 meter above ground (mb), 500 mb, 700 mb, 850 mb, 925 mb and 1000 mb for temperature. In the present invention, data id collected from 2 meters above the ground.

TABLE 9
NOAA data dictionary

| Short | | |
|---|---|---|
| Name | Full Name | Units |
| REFC | Composite reflectivity | dB |
| RETOP | Echo Top | M |
| VIL | Vertically Integrated Liquid Water | Kg/m\hat{ }2 |
| VIS | Visibility | M |
| REFD | Reflectivity | dB |
| GUST | Wind Speed (Gust) | m/s |
| UPHL | Updraft Helicity over Layer 2 km to 5 km | m\hat{ }2/s\hat{ }2 |
| | AGL | |
| UGRD | U-Component of Wind | m/s |
| VGRD | V-Component of Wind | m/s |
| PRES | Pressure | pa |
| HGT | Geopotential Height | gpm |
| TMP | Temperature | K |
| SPFH | Specific Humidity | kg/kg |
| DPT | Dew Point Temperature | K |
| WIND | Wind Speed | m/s |
| DSWRF | Downward Short-Wave Radiation Flux | W/m\hat{ }2 |
| VBDSF | Visible Beam Downward Solar Flux | W/m\hat{ }2 |
| CPOFP | Percent frozen precipitation | % |
| PRATE | Precipitation Rate | kg/m\hat{ }2/s |
| CSNOW | Categorical Snow | Categorical |
| | | variable |
| CICEP | Categorical Ice Pellets | Categorical |
| | | variable |
| CFRZR | Categorical Freezing Rain | Categorical |
| | | variable |
| CRAIN | Categorical Rain | Categorical |
| | | variable |
| ULWRF | Upward Long-Wave Rad. Flux | W/m\hat{ }2 |
| DLWRF | Downward Long-Wave Rad. Flux | W/m\hat{ }2 |
| USWRF | Upward Short-Wave Radiation Flux | W/m\hat{ }2 |
| VDDSF | Visible Diffuse Downward Solar Flux | W/m\hat{ }2 |

### Example 2

In this example, the results of implementing the models in other cities (Syracuse and Chicago) that have different climate types from San Antonio are shown. Following the similar process as above, the closest PWSs were chosen that are also always available of each season, to CoE (target building in Syracuse) for the process of selecting optimal parameters. Table 10 summarizes PWS that were selected. KNYHOMER2 is located 0.73 miles away from CoE and the distance between KNYSYRAC37 and CoE is 0.25 miles.

TABLE 10
Selected periods and target stations at different seasons

| Season | Target PWS ID | Period |
|---|---|---|
| Spring | KNYHOMER2 | 2020 Mar. 28~2020 Apr. 4 |
| Summer | KNYHOMER2 | 2020 May 20~2020 May 27 |
| Fall | KNYSYRAC37 | 2020 Oct. 1~2020 Oct. 8 |
| Winter | KNYSYRAC37 | 2020 Dec. 2~2020 Dec. 9 |

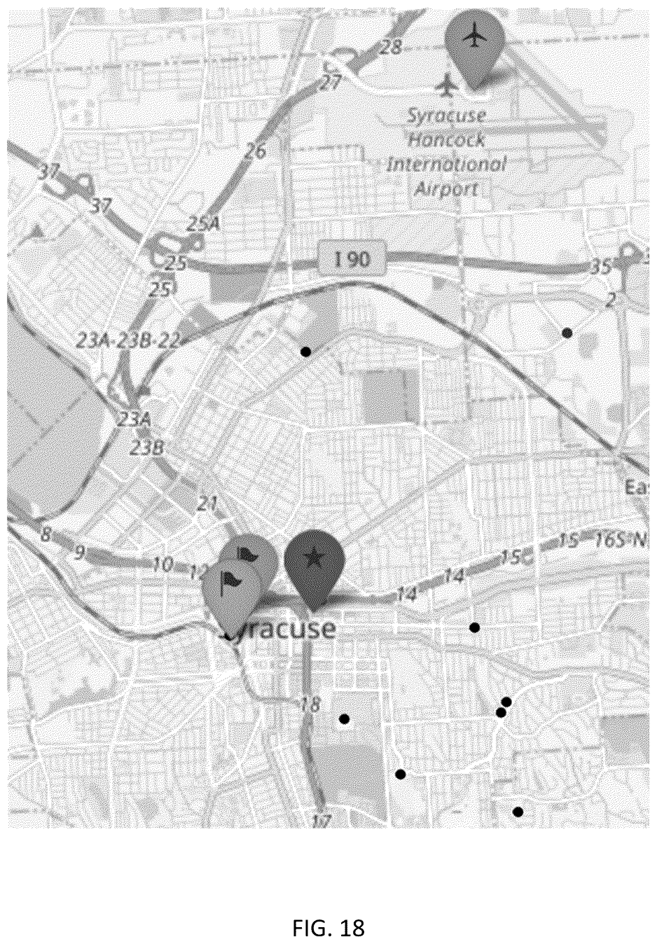

FIG. 18 is a map of Syracuse with selected PWSs. Orange flag icon represents PWS KNYHOMER2 and Red flag icon is KNYSYRAC37. Red star marks the CoE building and black solid circles are other PWSs in the surrounding area.

After finalizing PWSs for model validation purposes, the optimal parameters were identified for each season in Syracuse following the procedures above. Table 11 displays the optimal parameter selected for each season in Syracuse. Note that a feature selection process was only conducted in Spring as it was assumed the optimal feature stays unchanged in all other seasons.

TABLE 11
Selected optimal parameters and features in different seasons

| Season | Optimal Parameters | Optimal Features |
|---|---|---|
| Spring | R = 5; W = 96; L = 3.5 d | tempAvg; dLatdLon; |
| | (days) | winddirAvg, |
| Summer | R = 5; W = 96; L = 3.5 d | windgustAvg, pressureMax, |
| Fall | R = 20; W = 96; L = 3.5 d | pressure Min, pressureTrend, |
| Winter | R = 5; W = 24; L = 6 d | precipTotal, humidityAvg |

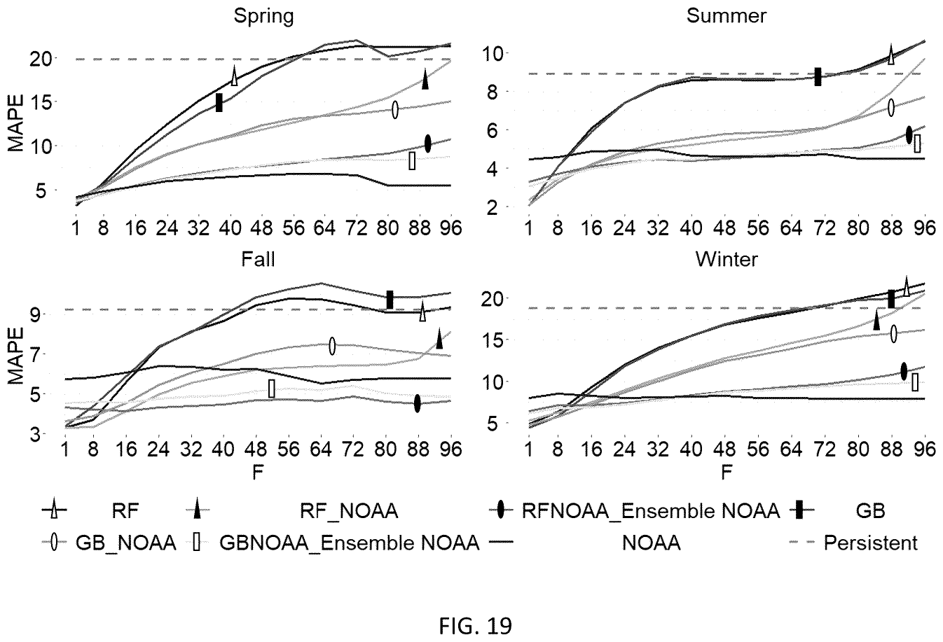

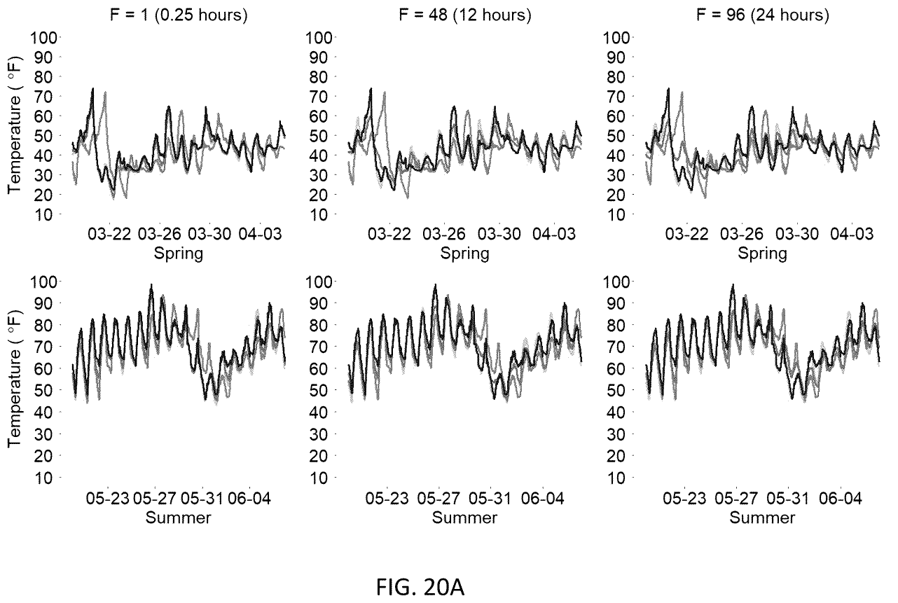

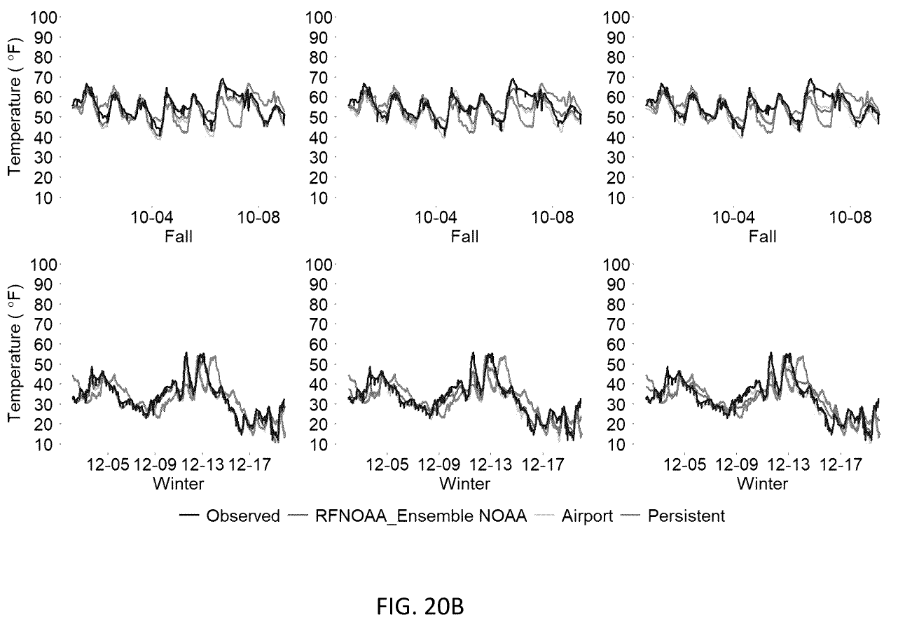

FIG. 19 shows the final performance of various models with optimal parameters in selected periods of all four seasons. Each line represents the MAPE of its corresponding model through different forecasting horizon Fs. The solid green dashed line is the performance of the persistent model. In general, all models perform better in summer and fall but not in spring and winter. On top of that, all models outperform the persistent model as majority parts of solid lines are below the green dashed line. The performance of the NOAA airport forecast (dark blue) stays almost constant through all forecasting horizon points. Random forest and gradient boosting machine learning algorithms produce similar results with or without using NOAA ensemble features before F=72. Gradient boosting slightly outperforms random forest when F is greater than 72. Finally, both the performance of random forest and gradient boosting are significantly improved after using NOAA forecasts as input features and the performance of both models are further improved ensemble e.g., RF_NOAA (light orange line) is below line RF (dark red) and RFNOAA_EnsembleNOAA (orange line) is below RF_NOAA.

Moreover, the NOAA airport forecasts usually outperform both random forest and gradient boosting models in a long-term forecast (F>24). For instance, NOAA has the lowest MAPE among all models in spring when F is greater than eight based on Table 12 in spring. While the model shows advantage against NOAA in a short-term forecast (F<24) as most bold values are from the model. MAPE of RF is 2.03 but 4.45 for NOAA, which implies that the RF outperforms NOAA by 54.36%. NOAA beats the models in spring and winter in terms of mean and RFNOAA_EnsembleNOAA is better in summer and fall.

TABLE 12
Model performance (MAPE) at selected look-ahead windows

| Season | Model | F = 1 | F = 8 | F = 24 | F = 48 | F = 72 | F = 96 | Mean |
|---|---|---|---|---|---|---|---|---|
| Spring | Persistent | 19.82 | 19.82 | 19.82 | 19.82 | 19.82 | 19.82 | 19.82 |
| | NOAA | 4.16 | 4.78 | 5.93 | 6.63 | 6.62 | 5.44 | 5.59 |
| | RF | 3.13 | 5.82 | 12.48 | 19.02 | 21.31 | 21.27 | 13.84 |
| | RF_NOAA | 3.50 | 5.47 | 9.05 | 11.86 | 14.35 | 19.63 | 10.65 |
| | RFNOAA_EnsembleNOAA | 3.58 | 4.47 | 6.28 | 7.67 | 8.80 | 10.73 | 6.92 |
| Summer | Persistent | 8.91 | 8.91 | 8.91 | 8.91 | 8.91 | 8.91 | 8.91 |
| | NOAA | 4.45 | 4.56 | 4.91 | 4.61 | 4.72 | 4.47 | 4.62 |
| | RF | 2.03 | 4.06 | 7.40 | 8.58 | 8.74 | 10.57 | 6.90 |
| | RF_NOAA | 2.34 | 3.45 | 4.68 | 5.42 | 6.07 | 9.71 | 5.28 |
| | RFNOAA_EnsembleNOAA | 3.30 | 3.68 | 4.30 | 4.49 | 4.93 | 6.19 | 4.48 |
| Fall | Persistent | 9.19 | 9.19 | 9.19 | 9.19 | 9.19 | 9.19 | 9.19 |
| | NOAA | 5.71 | 5.79 | 6.38 | 6.25 | 5.68 | 5.78 | 5.93 |
| | RF | 3.30 | 3.69 | 7.33 | 9.42 | 9.42 | 9.31 | 7.08 |
| | RF_NOAA | 3.29 | 3.32 | 4.98 | 6.21 | 6.41 | 8.14 | 5.39 |
| | RFNOAA_EnsembleNOAA | 4.31 | 4.21 | 4.30 | 4.68 | 4.84 | 4.65 | 4.50 |
| Winter | Persistent | 18.79 | 18.79 | 18.79 | 18.79 | 18.79 | 18.79 | 18.79 |
| | NOAA | 7.95 | 8.47 | 7.95 | 8.19 | 7.85 | 7.83 | 8.04 |
| | RF | 4.77 | 6.25 | 11.97 | 16.76 | 19.02 | 21.76 | 13.42 |
| | RF_NOAA | 5.22 | 6.16 | 8.87 | 12.75 | 15.50 | 20.58 | 11.51 |
| | RFNOAA_EnsembleNOAA | 6.42 | 7.06 | 7.34 | 8.78 | 9.60 | 11.70 | 8.48 |

FIG. 19 is the time series plot of observed temperature from the target station as well as forecasting temperature (persistent, NOAA Airport and random forest ensemble with NOAA included) based on different forecasting horizons. It can be observed that the temperature change in summer and fall follow a strong daily pattern while there are no clear patterns in spring and winter. This explains the finding in FIG. 19 and Table 12 that the model has better performance in summer and fall but not in spring and winter. The model framework integrates the temporal factors for forecasting by utilizing lagged features (L). The weaker the temperature pattern is, the harder to predict the future change of temperature based on the past. In addition, time-series lines from each model almost overlap with each other except the persistent model. However, the model deviates from the true observed temperature when F increases. The most obvious one is the figure on the top right corner when F=96 in spring. The orange line (temperature forecasting from RF_EnsembleNOAA) deviates from the blue line (Observed temperature from personal weather station). While NOAA can still accurately predict the temperature as there is no obvious deviation of light blue line (NOAA Airport) from the true observed temperature.

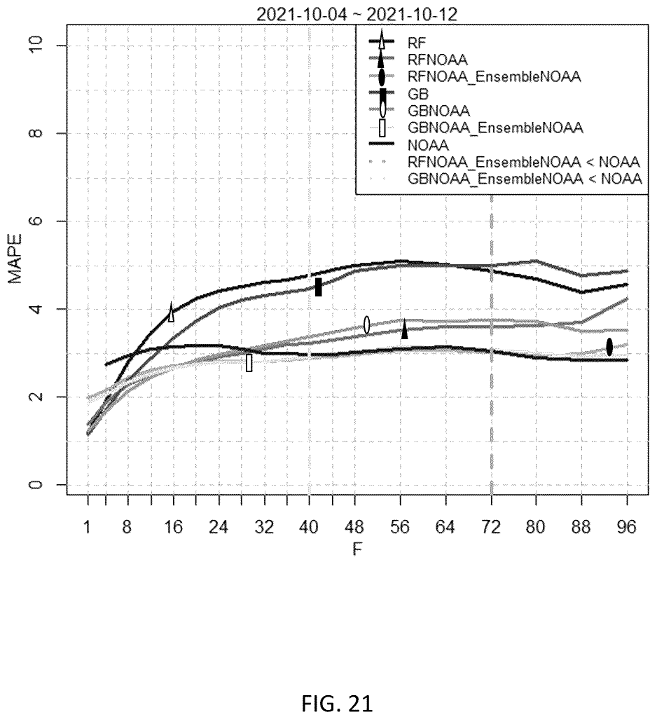

A simulation of deploying the model in a real-time setting with CoE building as a target location during the period of 2021 Oct. 4-2021 Oct. 12 was also conducted. All parameters (R, W, and L) are set to equal to the optimal parameters that were selected for fall season in Syracuse in Table 11. FIG. 21 is the results of this simulation. It may be concluded that in a real time setting the model framework can provide more accurate forecast than NOAA airport forecast for most forecasting horizon F with random forest including NOAA airport forecast inputs and further ensemble with NOAA (RFNOAA_EnsembleNOAA) and only lose the advantage over NOAA when F>72, which is equivalent to 18 hours looking ahead forecasting.

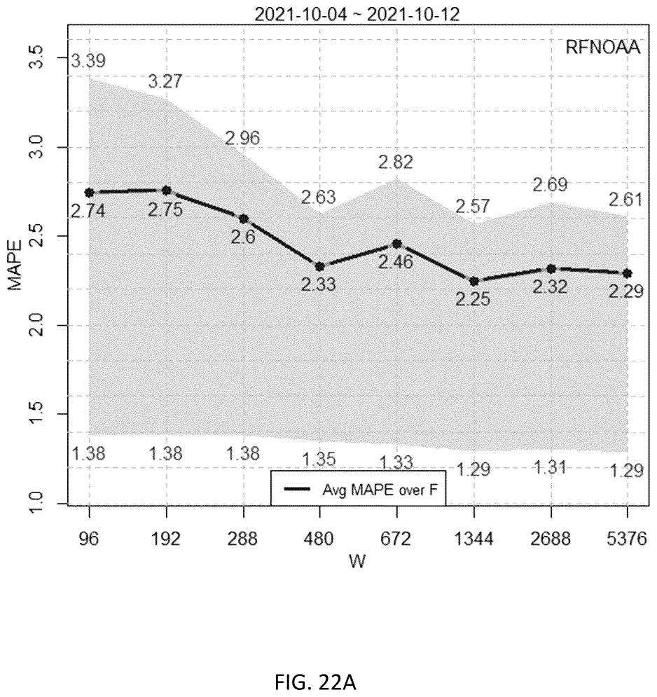

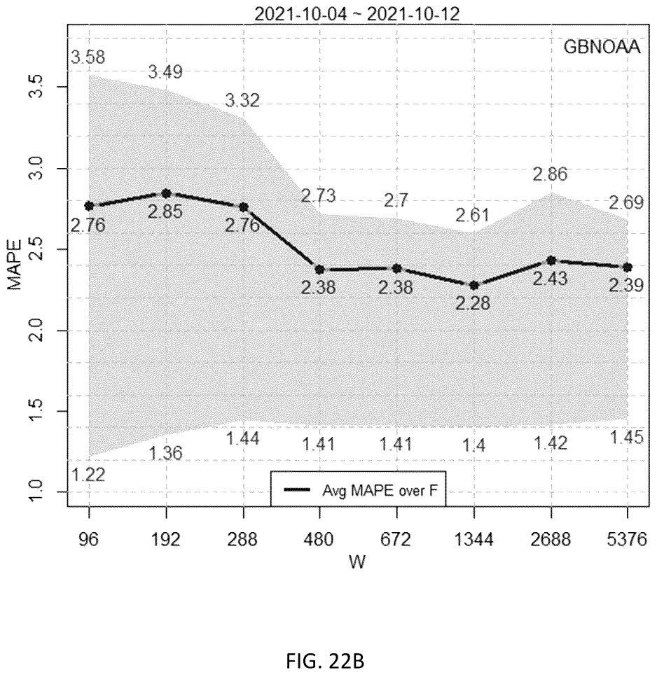

To further investigate how rolling-window (W) influences over the model's performance, a was conducted test by increasing the rolling window size from W=96 (one day) to W=5376 (eight weeks). FIG. 22 shows results of these tests. The dark red line (Average MAPE over F) in the middle, one can see that increasing W will increase the overall performance of both models. For instance, MAPE of random forest ensemble with NOAA feature (RFNOAA) decreases to 2.29 with W=5376 from 2.74 with W=96. However, the improvement is marginal with much longer computing time because the size of our training data is equal to R²×W.

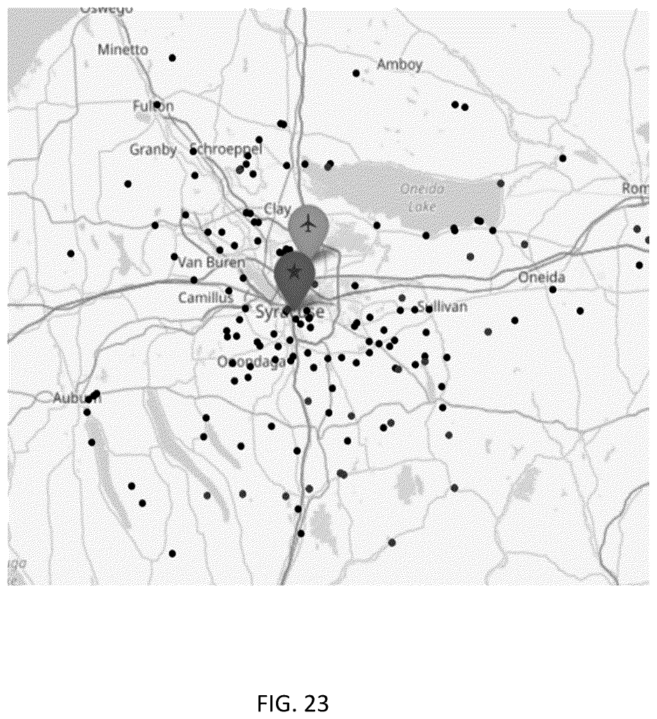

To test the general performance of the model in the entire city, ten stations were randomly chosen each season in Syracuse as target stations. FIG. 23 is the map with all the stations (red solid circle) that are selected.

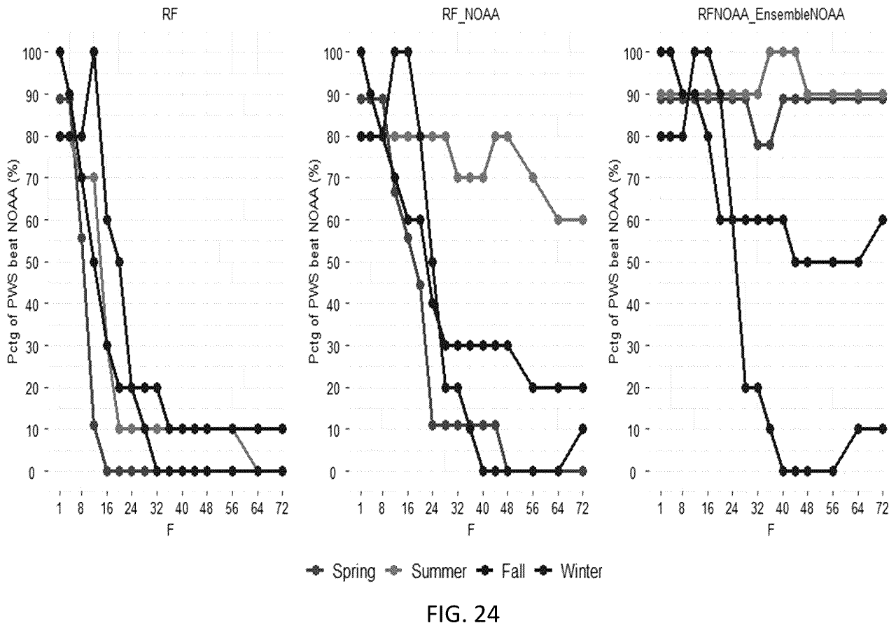

FIG. 24 shows the percentage of stations that beat NOAA forecasting in each season through different forecasting horizon points Fs. The model demonstrates obvious advantages over using NOAA airport forecasts in the short term (F<24 equivalent to six hours look ahead forecasting). For instance, the random forest model with NOAA forecast as feature input (RF_NOAA) is able to outperform NOAA airport forecast in all the locations in winter (blue line) at both F=16 (four hours ahead forecasting) and F=20 (five hours ahead forecasting). In addition, random forest with NOAA airport forecast as feature input and ensemble with airport forecast (RFNOAA_EnsembleNOAA) can outperform the NOAA airport forecast in majority selected stations through all forecasting horizon points in all seasons except winter because spring (green line), summer (orange line) and fall (dark red line) are all above 50%. Although, NOAA airport forecast is able to provide accurate temperature forecasts regarding CoE building, crowdsourcing data shows its advantage over airport forecasts when used to predict various locations that are far from the airport or have different landforms within the city.

Similar to above, ten stations were randomly selected around the city for each season in 2020 and then compare the model's performance with NOAA airport forecasts through different forecast horizon points in different season.

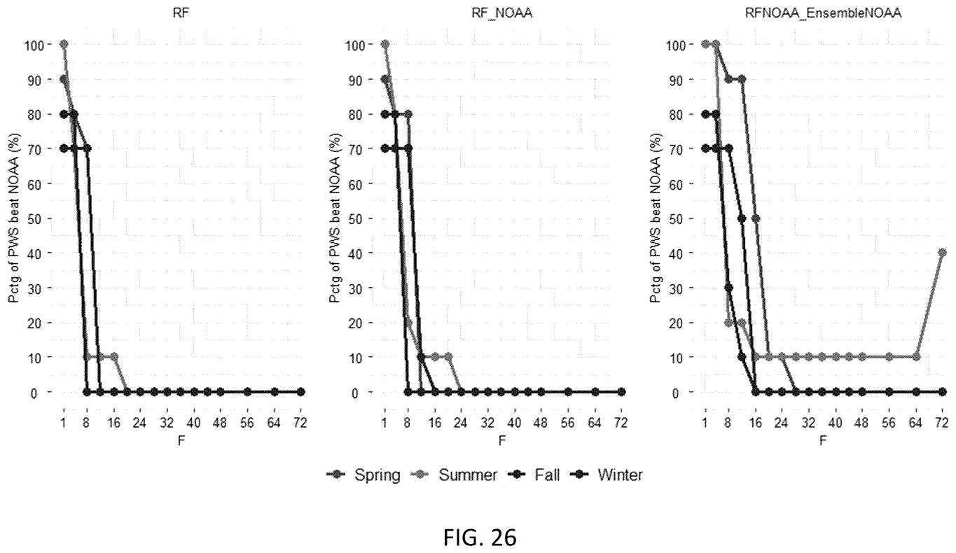

FIG. 26 shows the results of model implementation in Chicago. Although the model demonstrates advantages over NOAA airport forecasts in various locations of Syracuse, it is not the case here. In the short-term forecast (F<24), the model can still outperform NOAA. E.g., random forest with NOAA as feature input and ensemble with NOAA (RFNOAA_EnsembleNOAA) outperforms NOAA at all selected locations at F=1 (15 minutes) and F=4 (one hour) in summer as the orange line in the last figure is at 100 in the last figure. While the model loses advantage over NOAA when the look ahead forecasting range increases.

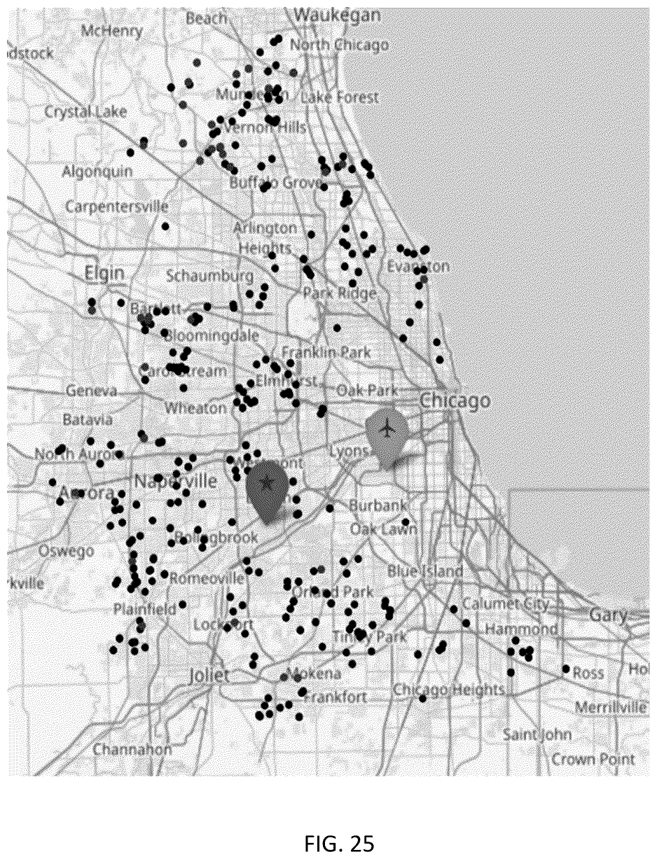

There are two reasons that may potentially cause the model to underperform NOAA airport forecast in Chicago but not in Syracuse. The first reason is the difference of terrain characteristics between Chicago and Syracuse. Chicago is in a relatively flat glacial plain. While there are rolling hills, flat plains, lakes, and streams in Syracuse. The landform of Syracuse is much more complicated than Chicago, which may cause the relatively larger temperature difference in different locations of Syracuse. In this kind of scenario, NOAA airport temperature cannot well present temperature in other locations in Syracuse. The temperature in Chicago, on the other hand, is much more uniform. Thus, the NOAA airport forecast can be applied to different locations. In addition, from FIG. 25, it may be seen that most stations selected (red solid circle) are located at the suburban area of Chicago so the heat island effect of an urban city may not be strong in these areas. In this case, the NOAA airport forecast can perform better as most airports are also located in suburban areas of cities.

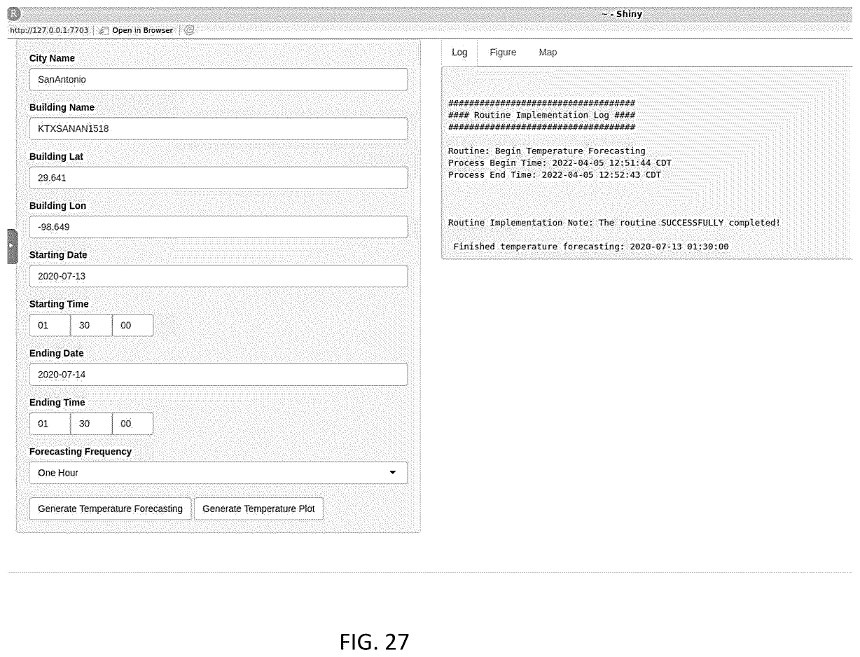

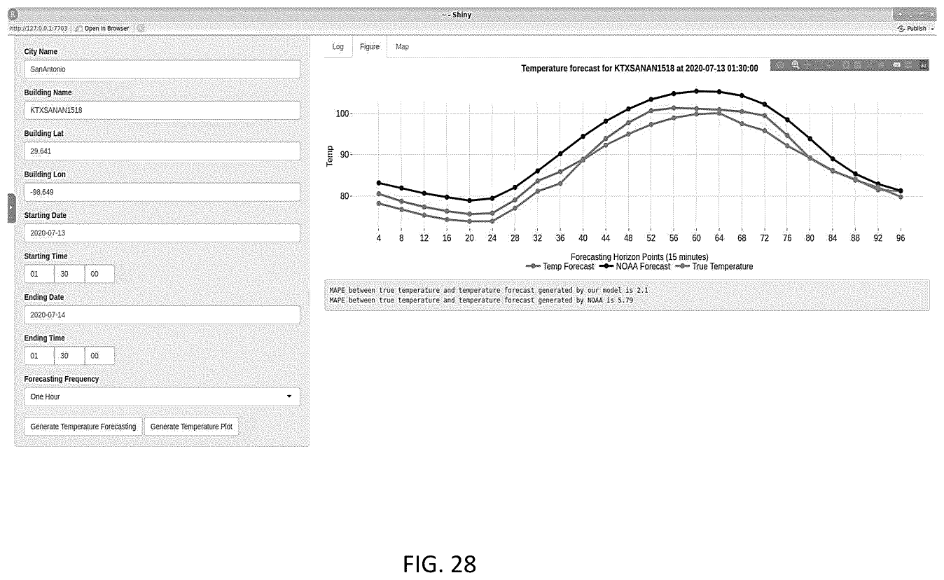

FIG. 27 shows an exemplary application design for implementing the present invention in software where left side panel allows user enter model inputs such as city, building name, location, forecasting starting and ending datetime. The main panel is where all outputs (e.g., log message, figure for temperature forecasting results and map) are generated by the model. FIG. 28 shows an exemplary output for a software application implementing the present invention.

What is claimed is:

1. A system for providing onside weather forecasting for a building in a predetermined location, comprising:
a source of crowdsourced weather data representing a plurality of personal weather stations in an area surrounding the predetermined location; and
a platform interconnected to the source of crowdsourced weather data, wherein the platform includes a processor programmed to provide a prediction of weather in the future at the predetermined location based upon the source of crowdsourced weather data using a spatial-temporal correlation of a predetermined set of weather features.

2. The system of claim 1, wherein the spatial-temporal correlation comprises a point to point correlation between each of the plurality of personal weather stations and the predetermined location of the building.

3. The system of claim 2, wherein the source of crowdsourced weather data includes a plurality of forecasts from the plurality of personal weather stations, respectively.

4. The system of claim 3, wherein the prediction of weather comprises an ensemble of the plurality of forecasts.

5. The system of claim 4, wherein the processor is programmed to provide the prediction of weather based on a machine learning model that has been trained using a set of historical weather features from the plurality of personal weather stations.

6. The system of claim 5, wherein the machine learning model comprises a random forest.

7. The system of claim 6, wherein the predetermined set of weather features comprises at least one endogenous temporal feature, at least one exogenous temporal feature, and at least one spatial feature.

8. The system of claim 7, wherein the processor is programmed to provide the prediction of weather according to a schedule.

9. The system of claim 8, wherein the schedule is every fifteen minutes.

10. The system of claim 9, wherein the historical weather features encompass up to a two day time period.

11. The system of claim 10, further comprising a source of public weather data representing at least one public weather station in the area surrounding the predetermined location.

12. The system of claim 11, wherein the at least one public weather station is a National Oceanic and Atmospheric Administration (NOAA) airport weather station.

13. The system of claim 12, wherein the source of public weather data from the at least one public weather station includes a series of forecasts.

14. The system of claim 13, wherein the prediction of weather comprises an ensemble of the plurality of forecasts from the plurality of weather stations and the series of forecasts from the at least one public weather station.
